(19) United States
(12) Patent Application Publication
(10) Pub. No.: US 2016/0261717 A1
(43) Pub. Date: Sep. 8, 2016

(54) INFORMATION PROCESSING APPARATUS, INFORMATION PROCESSING METHOD, AND INFORMATION PROCESSING SYSTEM

(71) Applicant: TOKYO ELECTRON LIMITED, Tokyo (JP)

(72) Inventors: Hiroshi YAMADA, Tokyo (JP); Toshiyuki TANIWAKI, Osaka (JP)

(21) Appl. No.: 15/155,169

(22) Filed: May 16, 2016

Related U.S. Application Data
(63) Continuation of application No. PCT/JP2014/080117, filed on Nov. 13, 2014.

(30) Foreign Application Priority Data
Nov. 18, 2013 (JP) 2013-238356

(51) Int. Cl. H04L 29/06; G06F 3/0484; G06F 3/0481

(52) U.S. Cl. CPC H04L 67/40; G06F 3/04817; G06F 3/04842

(57) ABSTRACT

An information processing apparatus for performing a process for operating a second information processing device by a first information processing device is provided. The apparatus includes an input processing means configured to perform a process for receiving input data based on an operation from the first information processing device and input data of an image based on an operation screen relating to the operation from the second information processing device, a restriction processing means configured to perform a process for performing a predetermined restriction on the input data of the operation or the input data of the image, and a storage means configured to store restriction data including a restriction process content according to a state of the second information processing device. The restriction processing means determines whether to perform the process for performing the predetermined restriction, based on the input data of the image and the restriction data.

### CROSS-REFERENCE TO RELATED APPLICATION

This application is a Continuation Application of PCT International Application No. PCT/JP2014/080117, filed Nov. 13, 2014, which claimed the benefit of Japanese Patent Application No, 2013-238356, filed Nov. 18, 2013, the entire content of each of which is hereby incorporated by reference.

### TECHNICAL FIELD

The present disclosure relates to an information processing apparatus, an information processing method, and an information processing system

### BACKGROUND

A device control system used to operate a device controlled through remote control has been known in the related arts. This system employs software for controlling both of a remotely controlled processing apparatus and a computer at a side for operation, thereby performing the remote control.

Further, the remote control of a device to be controlled at a remote site using a Keyboard Video Mouse (KVM) apparatus to connect a control device with the device to be controlled has been known.

However, in the remote control using the device control system or KVM apparatus described above, it is feared that an operator performing the remote control may perform a dangerous operation since it is difficult for the operator to know the state of the controlled device in order to operate the controlled device at a place spaced apart from the controlled device. For example, in manufacturing a semiconductor apparatus, it is presumed that a semiconductor manufacturing apparatus is installed in a clean room and an operator outside the clean room remotely operates the semiconductor manufacturing apparatus. In this case, if the operator performs the remote control in a state in which the operator is unable to know the surrounding environment or apparatus state of the manufacturing apparatus, the operator may perform a dangerous operation for the manufacturing apparatus.

Further, in the device control system described above, each of the controlling apparatus and the controlled device requires an installation of software for controlling or repairing hardware. Especially, in a semiconductor manufacturing apparatus, remarkable expense and time are required for repairing the hardware or software of the manufacturing apparatus.

### SUMMARY

An embodiment of the present disclosure has been made in view of the above tasks and provides an information processing apparatus, an information processing method, and an information processing system, which can reduce repairs of a controlling apparatus and a controlled device to easily construct the system and can ensure safety in remote controlling.

According to one embodiment of the present disclosure, there is provided an information processing apparatus for performing a process for operating a second information processing device by a first information processing device. The information processing apparatus includes an input processing means configured to perform a process for receiving input data based on an operation from the first information processing device and input data of an image based on an operation screen relating to the operation from the second information processing device, a restriction processing means configured to perform a process for performing a predetermined restriction on the input data of the operation or the input data of the image, and a storage means configured to store restriction data including a restriction process content according to a state of the second information processing device, wherein the restriction processing means is configured to acquire the state of the second information processing device based on the input data of the image acquired from the second information processing device, and determine whether to perform, the process for performing the predetermined restriction, based on the acquired state and the restriction data.

The present disclosure can reduce repairs of a controlling apparatus and a controlled device to easily construct a system and can ensure safety in remote controlling.

### BRIEF DESCRIPTION OF THE DRAWINGS

FIG. 1 is a conceptual view illustrating an example of a configuration of an information processing system according to an embodiment of the present disclosure.

FIG. 2 is a functional block diagram illustrating an example of an operator terminal according to an embodiment of the present disclosure.

FIG. 3 is a block diagram for describing an example of a hardware configuration of an operator terminal according to an embodiment of the present disclosure.

FIG. 4 is a functional block diagram for describing an example of a manufacturing apparatus according to an embodiment of the present disclosure.

FIG. 5 is a block diagram for describing an example of a hardware configuration of a manufacturing apparatus according to an embodiment of the present disclosure.

FIG. 6 is a functional block diagram for describing an example of a remote KVM apparatus according to an embodiment of the present disclosure.

FIG. 7 is a block diagram for describing an example of a hardware configuration of a remote KVM apparatus according to an embodiment of the present disclosure.

FIG. 8 is a flowchart for describing an example of an entire process by an information processing system according to an embodiment of the present disclosure.

FIG. 9 is a flowchart for describing an example of a decision process according to an embodiment of the present disclosure.

FIG. 10 is a view for describing an example of an operation screen according to an embodiment of the present disclosure.

FIG. 11A illustrates an example of an image to be subjected to a pattern matching process according to an embodiment of the present disclosure.

FIG. 11B illustrates an example of a template image of a pattern matching process according to an embodiment of the present disclosure.

FIG. 11C illustrates an example of a state in which an image to be subjected to a pattern matching process according to an embodiment of the present disclosure has been divided into template images.

FIG. 12 illustrates a Table for describing an example of setting data according to an embodiment of the present disclosure.

FIG. 13 is a flowchart for describing an example of a restriction process of a first embodiment according to an embodiment of the present disclosure.

FIG. 14 is a view for describing an example of a restriction process of the first embodiment according to an embodiment of the present disclosure.

FIG. 15 is a flowchart for describing an example of a decision process of a second embodiment according to an embodiment of the present disclosure.

FIG. 16A illustrates an example of an operation screen in a previous decision process of the second embodiment according to an embodiment of the present disclosure.

FIG. 16B illustrates an example of an operation screen in a current decision process of the second embodiment according to an embodiment of the present disclosure.

FIG. 16C illustrates an example of a differential image generated in a decision process of the second embodiment according to an embodiment of the present disclosure.

FIG. 17 is a flowchart for describing an example of a restriction process of a second embodiment according to an embodiment of the present disclosure.

FIG. 18A illustrates an example of a differential image generated in a mask process of the second embodiment according to an embodiment of the present disclosure.

FIG. 18B illustrates an example of a differential image having been subjected to a mask process of the second embodiment according to an embodiment of the present disclosure.

FIG. 18C illustrates an example of a desktop screen generated by a synthesis in the second embodiment according to an embodiment of the present disclosure.

FIG. 18D illustrates an example of a desktop screen in which a differential image has not been mask-processed in the second embodiment according to an embodiment of the present disclosure.

FIG. 19 is a flowchart for describing an example of a restriction process of a third embodiment according to an embodiment of the present disclosure.

FIG. 20A illustrates an example of a desktop screen mask-processed in the third embodiment according to an embodiment of the present disclosure.

FIG. 20B illustrates an example of mask data used for a mask process of the third embodiment according to an embodiment of the present disclosure.

FIG. 20C illustrates an example of a desktop screen mask-processed in the third embodiment according to an embodiment of the present disclosure.

FIG. 21A illustrates an example of a widget, which is located in the other area except for the clickable area of FIG. 20B and has been subjected to a mask process of non-display.

FIG. 21B illustrates an example of invalidating a widget, which is located in the other area except for the clickable area of FIG. 20B, by making the widget become semi-transparent.

FIG. 21C illustrates an example of invalidating the other area except for the clickable area of FIG. 20B by painting the other area by black color.

FIG. 21D illustrates an example in which a part of icons have been subjected to the mask process of non-display.

FIG. 21E illustrates an example in which a part of a window has been subjected to the mask process of non-display.

### DETAILED DESCRIPTION

The present disclosure relates to an information processing apparatus used to perform

remote control through a network, which is a so-called remote KVM apparatus. Hereinafter, embodiments of the present disclosure will be described. A remote control is achieved by building a system, using a remote KVM apparatus.

### First Embodiment

As the first embodiment, examples of an information processing apparatus and an information processing system according to an embodiment of the present disclosure will be described.

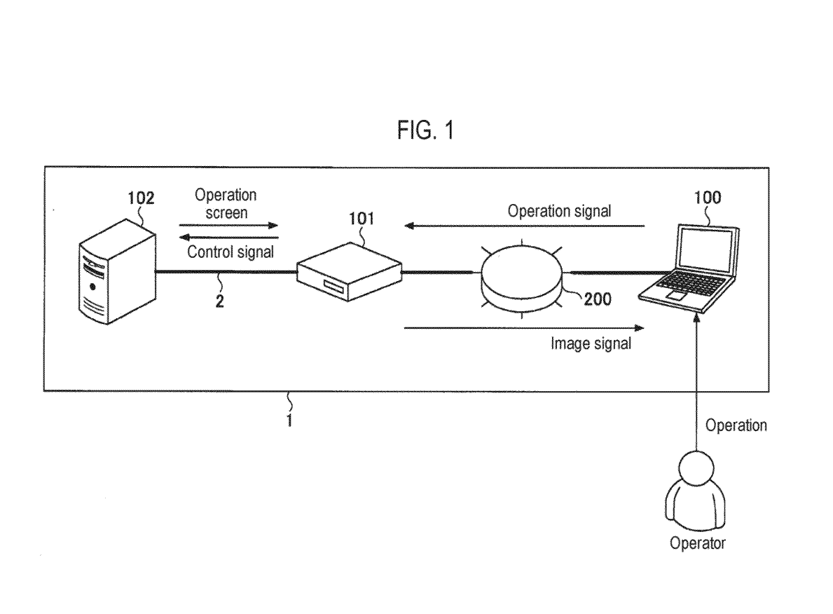

FIG. 1 is a conceptual view illustrating an example of a configuration of an information processing system according to an embodiment of the present disclosure.

The information processing system 1 includes a first information processing device 100, an information processing apparatus 101, and a second information processing device 102. The first information processing device 100 and the information processing apparatus 101 are connected to each other through a network 200. The information processing apparatus 101 and the second information processing device 102 are connected to each other through a cable 2.

The first information processing device 100 is, for example, an apparatus (hereinafter, referred to as an operator terminal) through which an operator inputs an instruction for operating the second information processing device 102. The first information processing device 100 will he described later in detail.

The information processing apparatus 101 is a remote KVM apparatus. The information processing apparatus 101 will be described later in detail.

The second information processing device 102 is, for example, a manufacturing apparatus (hereinafter, referred to as a manufacturing apparatus) for manufacturing, for example, a semiconductor device. The second information processing device 102 will be described later in detail.

The network 200 is a wired or wireless communication line, such as a Local Area Network (LAN), a Wide Area Network (WAN), or the Internet.

Further, the network 200 may be configured with a plurality of networks. For example, the network 200 may be configured with two or more networks connected through a node, such as a separate server, a router, or an access point.

Further, the present disclosure is not limited to the case where the first information processing device 100 is a device for inputting an instruction for operating the second information processing device 102 while the second information processing device 102 is a device to be operated. For example, the present disclosure includes a case where the second information processing device 102 is configured as a device for inputting an instruction for operating the first information processing device 100 while the first information processing device 100 is configured as a device to be operated. That is, a configuration in which the first information processing device 100 and the second information processing device 102 can be interchanged.

### Operator Terminal

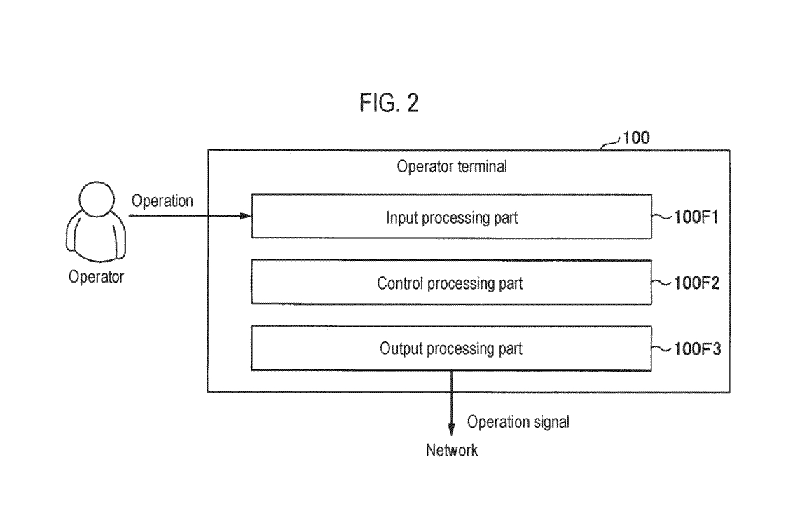

FIG. 2 is a functional block diagram illustrating an example of an operator terminal according to an embodiment of the present disclosure.

The operator terminal 100 includes an input processing part 100F1, a control processing part 100F2, and an output processing part 100F3.

The input processing pail 100F1 is configured to perform processing for inputting an instruction to the operator terminal 100. For example, the input processing part 100F1 is configured to receive an operation input, such as a command input, two-dimensional coordinate information, a switching operation by a mouse click or the like, through a GUI (Graphical User Interface) and an input apparatus, such as a keyboard, or a pointing device, such as a mouse, which will be described below, and convert the received operation input into data or a signal through processing, such as A/D conversion. Further, the input processing part 100F1 may perform, a conversion or processing upon input data into a form readable at processing of a post stage or a form to be processed at a high speed. Further, the input processing part 100F1 may perform processing to delete information, which is unnecessary at the processing of the post stage, such as header data used in communication for the input, from the input data.

The control processing part 100F2 controls devices included in the operator terminal 100 or an external device (not shown) connected to the operator terminal 100 by a CPU 100H3, which will be described later.

The output processing part 100F3 performs processing to convert data or a signal based on the operation received by the input processing part 100F1 from the operator terminal 100 into an operation signal and to output the operation signal. For example, the output processing part 100F3 transmits the operation signal to the remote KVM apparatus 101 through the network 200, using a network I/F, which will be described later. Further, the output processing part 100F3 may perform, as a pre-processing of the outputting process, processing to convert the signal into a form readable by an output destination or processing to add the header data to the signal in order to transmit the signal through the network 200.

### Hardware Configuration of Operator Terminal

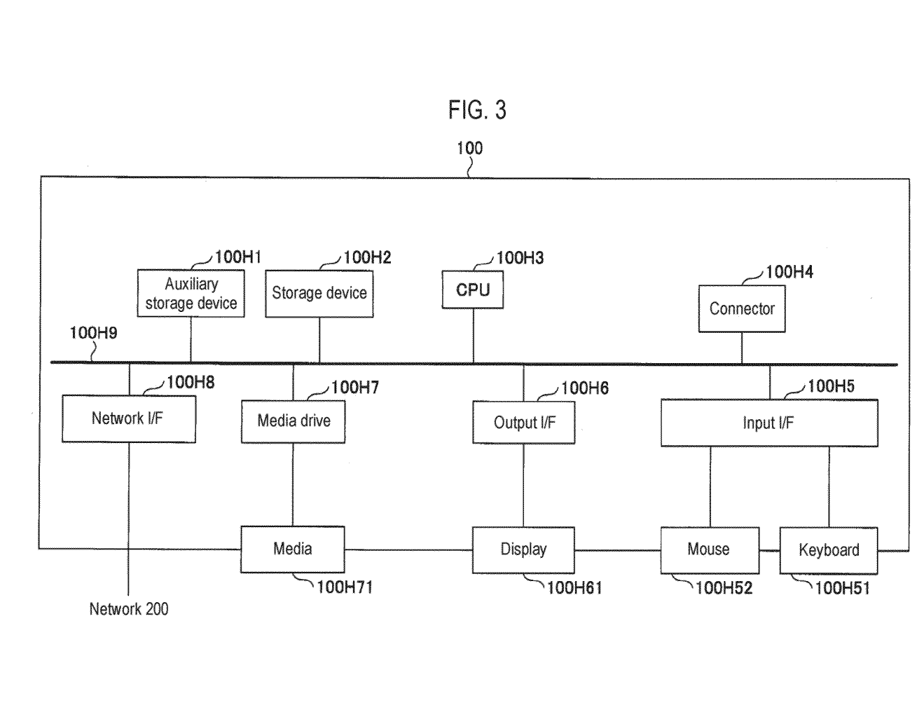

FIG. 3 is a block diagram for describing an example of a hardware configuration of an operator terminal according to an embodiment of the present disclosure.

The operator terminal 100 is a computer. The operator terminal 100 may be configured with, for example, a PC (Personal Computer), a server, or a main frame.

Further, the operator terminal 100 may be a mobile device, such as a PDA (Personal Digital Assistant), a tablet PC, a smart phone, or a portable phone.

The operator terminal 100 includes an auxiliary storage device 100H1, a storage device 100H2, a CPU (Central Processing Unit) 100H3, a connector 100H4, an input I/F 100H5, an output I/F 100H6, and a media drive 100H7.

Further, the operator terminal 100 has a network I/F 100H8 and is connected to the network 200.

The respective elements of the operator terminal 100 are connected to each other through a bus 100H9. Further, the connection to the bus 100H9 may be a configuration connected through a bridge circuit (not shown). Further, the configuration of the operator terminal 100 is not limited to the configuration illustrated in FIG. 3. For example, the bus 100H9 may include a plurality of buses. For example, the operator terminal 100 may have a configuration in which a bus for high speed transmission, such as the CPU 100H3, and a bus for low speed transmission, such as the I/F 100H5, are different from each other and are connected to each other through a bridge circuit (not shown).

The auxiliary storage device 100H1 stores information, such as various data, parameters, or programs, which includes an intermediate result of the process performed by the CPU 100H3, under the control of the CPU 100H3 and a control apparatus (not shown). The auxiliary storage device 100H1 may be, for example, a hard disk or a flash SSD (Solid State Drive).

The storage device 100H2 is a storage area used by a program executed by the CPU 100H3, that is, a main storage device, such as a so-called memory. The storage device 100H2 stores information, such as data, a program, or a parameter.

The CPU 100H3 performs calculation and control for various processes performed by the operator terminal 100. For example, the CPU 100H3 performs inputting/outputting of information among the auxiliary storage device 100H1, the storage device 100H2, the input I/F 100H5, and the output I/F 100H6 through the bus 100H9. Further, the CPU 100H3 executes various programs.

The CPU 100H3 may be configured with a plurality of CPUs or a plurality of cores to operate at a high speed through parallel processing. Further, the processing of the CPU 100H3 may be performed with another hardware resource provided inside or outside the operator terminal 100 as an assistance of the CPU 100H3.

The storage area used by a program executed by the CPU 100H3 is not limited to the storage area of the storage device 100H2. For example, a so-called virtual memory method using the storage area of the auxiliary storage device 100H1 as the storage area used by the CPU 100H3 may be used.

The connector 100H4 is a bus, which is connected to an external device (not shown) to perform inputting/outputting with the external device, a so-called external bus. The connector 100H4 may be configured with, for example, a USB (Universal Serial Bus). The connector 100H4 may be an IEEE (The Institute of Electrical and Electronics Engineers, Inc.) 1394, Thunderbolt™ or the like. The connector 100H4 has a connector shape according to the standard, a physical connection terminal, such as a connecting pin, a processing circuit (not shown) for processing a signal input through the connection terminal, and a driver (not shown). The connector 100H4 is not limited to a connector for a wired circuit. For example, a connector for a wireless circuit, such as Bluetooth™, may be used.

The input I/F 100H5 is an interface for connecting an input apparatus to the operator terminal 100. The input apparatus includes, for example, a keyboard 100H51 through which a value required for processing or command is input. The input apparatus may be a mouse

100H52 for inputting a two dimensional moving distance to the operator terminal 100. Further, the input apparatus may be a pointing device, such as a pen tablet. The input apparatus may be configured to be connected to the connector 100H4.

The output I/F 100H6 is an interface for connecting a display 100H61, which is an output apparatus for displaying a processing result, etc., a processing circuit (not shown) for controlling an image signal outputted at the display 100H61, a driver (not shown), and a cable (not shown). The output apparatus may be a projecting device, such as a projector, instead of the display 100H61.

Further, the input apparatus connected to the input I/F 100H5 and the output apparatus connected to the output I/F 100H6 may be a device having an input apparatus and an output apparatus integrally formed therein, that is, a so-called touch panel,

The media drive 100H7 connects with a media 100H71, which is a recording media, to perform processing for inputting or outputting information. The media 100H71 is a CD-ROM (Compact Disc-Read Only Memory), a DVD (Digital Versatile Disc), or an optical disc such as a Blu-ray. The media 100H71 may be a magnetic disc, such as a flexible disc, or a flash memory, such as SD(tm) card or compact flash(tm). Further, information may be input or output by connecting a USB memory to a connector 100H4 or through a network 1/F 100H8, which will be described later. Further, the operator terminal 100 may be configured without the media drive 100H7.

The network I/F 100H8 is an interface for connecting the operator terminal 100 to a network, such as LAN, in a wired or wireless manner. The network I/F 100H8 has a connector shape conforming with a standard, such as IEEE, a physical connection terminal, such as a connection pin, a cable for physically connecting the operator terminal 100 with a line, a processing circuit (not shown) for processing a signal input through a connection terminal, and a driver (not shown). The operator terminal 100 may be connected to another network or the Internet through the LAN.

The bus 100H9 is used for communication between the elements of the operator terminal 100. The bus 100H9 is a so-called internal bus. The bus 100H9 is, for example, a PCI Express (Peripheral Component Interconnect Express). The bus 100H9 may be a PCI or an ISA (Industry Standard Architecture).

Further, the operator terminal 100 may be implemented with an ASIC (Application Specific Integrated Circuit) of a circuit capable of executing the whole or a part of same processing as ASIC (Application Specific Integrated Circuit), instead of using various programs to execute the same processing. Instead of the ASIC, the operator terminal 100 may be implemented with the circuit through an FPGA (Field-Programmable Gate Array) or CPLD (Complex Programmable Logic Device).

Further, the hardware configuration described above is an example and the operator terminal 100 may not have all the described elements. Also, the operator terminal 100 may have another element in addition to the described elements or have the described elements redundantly to be multiplexed.

### Manufacturing Apparatus

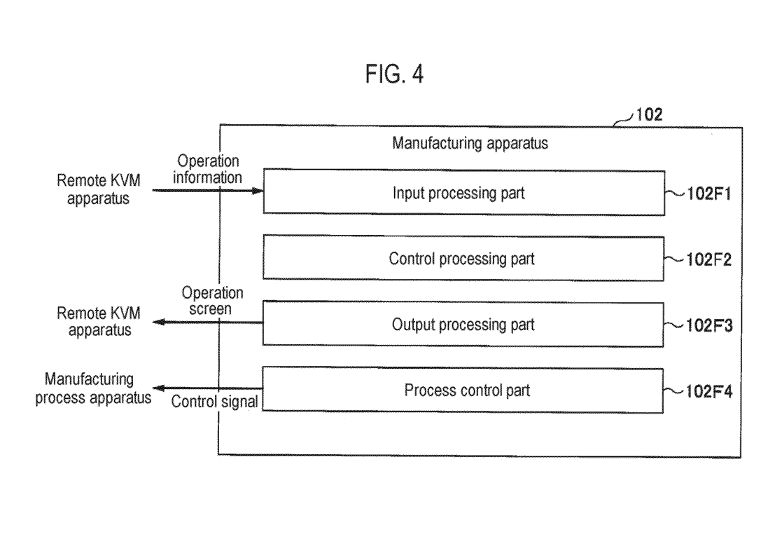

FIG. 4 is a functional block diagram for describing an example of a manufacturing apparatus according to an embodiment of the present disclosure.

The manufacturing apparatus 102 is, for example, an apparatus for manufacturing a semiconductor device. Specifically, the manufacturing apparatus is an apparatus configured to perform coating and developing a photoresist in a photolithograpy process of semiconductor manufacturing processes. Hereinafter, a manufacturing apparatus of a semiconductor device will be described as an example.

The manufacturing apparatus 102 includes an input processing part 102F1, a control processing part 102F2, an output processing part 102F3, and a process control part 102F4.

The input processing part 102F1 performs processing for inputting operation information based on an instruction input to the operator terminal 100 by an operator. The input processing part 102F1 receives, by a network I/F described below, the operation information from the operator terminal 100 through the network 200. For example, the input processing part 102F1 receives an operation signal corresponding to a command of pressing a GUI button for controlling the operation of the process control part 102F4 through remote control of the operator. The input processing part 102F1 is not limited to perform operations of receiving and processing the operation signal. For example, the input processing part 102F1 may receive a parameter or data, such as a numerical value related to the configuration of a manufacturing apparatus, as operation information.

Further, the input processing part 102F1 may convert or process the input data into a form readable at processing of a post stage or a form to be processed at a high speed. Further, the input processing part 102F1 may perform processing to delete information, which is unnecessary at the processing of the post stage, such as header data used in communication for the input, from the input data.

The control processing part 102F2 controls devices included in the manufacturing apparatus 102 or an external device (not shown) connected to the manufacturing apparatus 102 or the process control part 102F4, by a CPU 102H3 described below. For example, the control processing part 102F2 performs a control operation to operate the process control part 102F4 based on an operation signal for operating the process control part 102F4, which is input at the input processing unit 102F1.

The control processing part 102F2 generates, by the CPU 102H3 described below, an operation screen including a GUI for operating the manufacturing apparatus 102, and outputs the generated operation screen to an output processing part 102F3, which will be described below.

The output processing part 102F3 outputs the operation screen, which is image data for operating the manufacturing apparatus 102, by the CPU 102H3 described below and an image output connector 102H4 described below. The operation screen output from the output processing part 102F3 is output to the remote KVM apparatus 101 and then transmitted to the operator terminal 100 through the remote KVM apparatus 101 and the network 200. The operation screen output from the output processing part 102F3 is output to the remote KVM apparatus 101 to be output to an output apparatus connected to the remote KVM apparatus 101.

The process control part 102F4 controls a manufacturing process apparatus 1022, which is described below, by a control apparatus (not shown), etc.

### Hardware Configuration of Manufacturing Apparatus

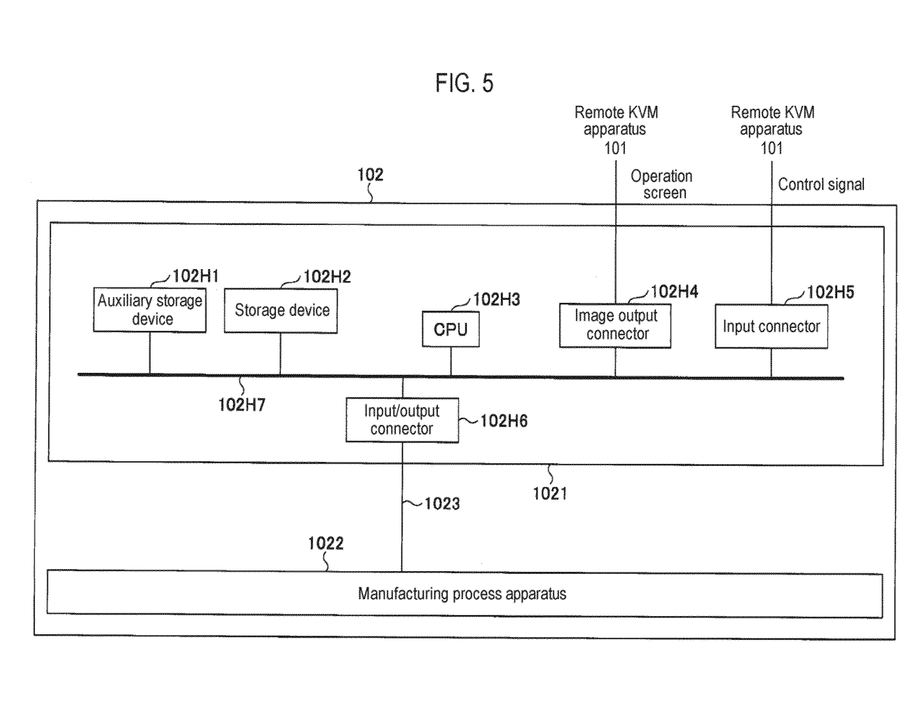

FIG. 5 is a block diagram for describing an example of a hardware configuration of a manufacturing apparatus according to an embodiment of the present disclosure.

The manufacturing apparatus 102 includes an information processing apparatus 1021 and a manufacturing process apparatus 1022. The information processing apparatus 1021 and the manufacturing process apparatus 1022 are connected to each other through a cable 1023.

The information processing apparatus 1021 may be a computer. For example, the information processing apparatus 1021 may be a PC, a server, or a main frame.

he information processing apparatus 1021 includes an auxiliary storage device 102H1, a storage device 100H2, a CPU 100H3, an image output connector 102H4, an input connector 102H5, and an input/output connector 102H6.

The elements of the information processing apparatus 2021 are connected to each other through a bus 102H7. Further, the connection to the bus 102H7 may be configured to be connected through a bridge circuit (not shown). Further, the configuration of the information processing apparatus 1021 is not limited to the configuration illustrated in FIG. 5. For example, the bus 102H7 may include a plurality of buses. For example, the information processing apparatus may have a configuration in which a bus for high speed transmission, such as the CPU 102H3, and a bus for low speed transmission, such as the input/output connector 102H6, are different from each other and are connected to each other through a bridge circuit (not shown).

The auxiliary storage device 102H1 stores information, such as various data, parameters, or programs, which includes an intermediate result of a process performed by the CPU 102H3, under the control of the CPU 102H3 and a control apparatus (not shown). The auxiliary storage device 102H1 may be, for example, a hard disk or a flash SSD.

The storage device 102H2 is a storage area used by a program executed by the CPU 102H3, that is, a main storage device, such as a so-called memory. The storage device 102H2 stores information, such as data, a program, or a parameter.

The CPU 102H3 performs calculation arid control for various processes performed by the information processing apparatus 1021. For example, the CPU 102H3 performs inputting/outputting of information among the auxiliary storage device 102H1, the storage device 102H2, the input/output connector 102H6 through the bus 102H7. Further, the CPU 102H3 executes various programs.

The CPU 102H3 may be configured with a plurality of CPUs or a plurality of cores to operate at a high speed through parallel processing. Further, the processing of the CPU 102H3 may be performed with another hardware resource provided inside or outside the information processing apparatus 1021 as an assistance of the CPU 102H3.

The storage area used by a program executed by the CPU 102H3 is not limited to the storage area of the storage device 102H2. For example, a so-called virtual memory method using the storage area of the auxiliary storage device 102H1 as the storage area used by the CPU 102H3 may be used.

The image output connector 102H4 and the input connector 102H5 are so-called external buses, which are buses connected to an external apparatus, such as the KVM apparatus 101, to input or output data or a control signal to or from the external apparatus.

The image output connector 102H4 is an interface for transmitting an image signal, for example, a D-Sub15 pin connector for analog RGB (Red Green Blue), an HDMI™ (High Definition Multimedia Interface), a DVI (Digital Visual Interface) or the like.

The input connector 102H5 is an interface for transmitting a control signal, for example, a PS/2 connector, a USB, or an RS-232C (Recommended Standard 232C). The input connector 102H5 may be an IEEE (The Institute of Electrical and Electronics Engineers, Inc.) 1394 or Thunderbolt™.

The image output connector 102H4 and the input connector 102H5 have a connector shape according to a standard, a physical connection terminal, such as a connecting pin, a processing circuit (not shown) for processing a signal input through the connection terminal, and a driver (not shown). The input connector 102H5 is not limited to a connector for a wired circuit. For example, a connector for a wireless circuit, such as Bluetooth™, may be used. The input connector 102H5 may have a circuit (not shown) for performing processes of decoding/encoding data in a form allowing the remote KVM apparatus 101 to receive the data, or performing timing adjustment for synchronization with a reception part.

The image output connector 102H4 and the input connector 102H5 may be configured with a plurality of connectors, processing circuits, and cables.

The input/output connector 102H6 is an interface for transmission or reception of an input/output signal for controlling the manufacturing process apparatus 1022.

For example, the input/output connector 102H6 has a D/A conversion circuit (not shown) and an output connector (not shown), and connects the cable 1023 to the output connector. The input/output connector 102H6 generates a control signal for controlling the manufacturing process apparatus 1022 based on an input signal input from the remote KVM apparatus 101 through the input connector 102H5.

For example, the input/output connector 102H6 has an A/D conversion circuit (not shown) and an input connector (not shown), and connects the cable 1023 to the input connector. The input/output connector 102H6 receives a control signal output from the manufacturing process apparatus 1022 to recognize a state of the manufacturing process apparatus 1022.

The manufacturing apparatus 102 generates an operation screen for operating the manufacturing process apparatus 1022 based on a control signal input to or output from the input/output connector 102H6, and outputs an image to the remote KVM apparatus 101 through the image output connector 102H4.

The manufacturing apparatus 102 generates a signal for operating the manufacturing process apparatus 1022 based on a control signal input from the remote KVM apparatus 101 through the input connector 102H5, and controls the manufacturing process apparatus 1022 to execute a manufacturing process.

Further, the manufacturing apparatus 102 recognizes the state of the manufacturing apparatus 102 by various sensors (not shown) mounted in the manufacturing process apparatus 1022, generates operation screen data reflecting the grasped state, and outputs an image signal to the remote KVM apparatus 101 based on the generated operation screen.

The second information processing device 102 is not limited to the manufacturing apparatus. For example, the second information processing device 102 may be an information processing device, such as a PC, a server, or a main frame. Further, the second information processing device may be an information processing device for controlling an apparatus for another FA (Factory Automation), a robot, or a mechanical working apparatus.

### Remote KVM Apparatus

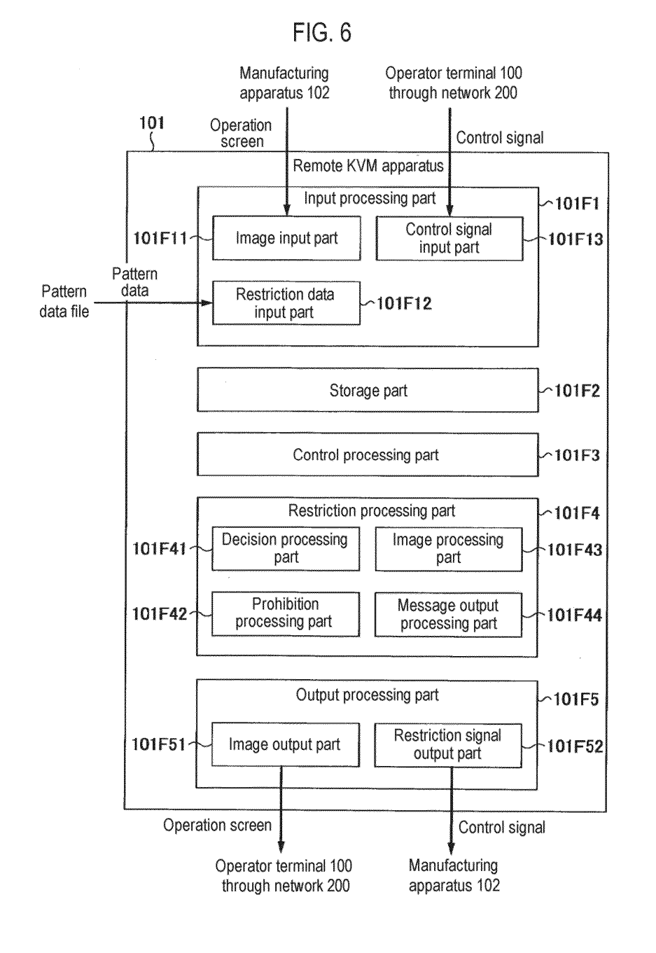

FIG. 6 is a functional block diagram for describing an example of a remote KVM apparatus according to an embodiment of the present disclosure.

The remote KVM apparatus 101 includes an input processing part 101F1, a storage part 101F2, a control processing part 101F3, a restriction processing part 101F4, and an output processing part 101F5.

The input processing part 101F1 includes an image input part 101F11, a restriction data input part 101F12, and a control signal input part 101F13.

The input processing part 101F1 receives an input signal from another apparatus through each connector and performs processing for inputting a signal and data to the remote KVM apparatus 101. The input data is generated through processing, such as conversion, on an input signal.

The image input part 101F11 performs processing for inputting image data for an operation screen by receiving an image signal from the manufacturing apparatus 102 and generating the image data based on the received image signal.

The restriction data input part 101F12 performs processing for inputting restriction data for restricted processing from a storage medium, etc. The restriction data will be described below in detail.

The control signal input part 101F13 receives a control signal for operating the manufacturing apparatus 102 from the operator terminal 100.

Further, the input processing part 101F1 may convert data into a predetermined format or delete unnecessary data as pre-processing of the processing of the post stage.

The storage part 101F2 stores information, such as data, parameters, and data as an intermediate processing result of each processing, in a storage device 101H2, which will be described below. The storage part 101F2 stores various data input from the input processing part 101F1 in the storage device, which is described below.

The control processing part 101F3 controls each device of the remote KVM apparatus 101 by a calculation device 101H1 described below and a control apparatus (not shown) of each apparatus.

The restriction processing part 101F4 performs a restriction process described below by the calculation device 101H1 described below.

The restriction processing part 101F4 includes a decision processing part 101F41, a prohibition processing part 101F42, an image processing part 101F43, and a message output processing part 101F44.

The decision processing part 101F41 performs decision processing described below by the calculation device 101H1 described below.

The prohibition processing part 101F42, the image processing part 101F43, and the message output processing part 1G1F44 perform various restriction processes, which are described below, based on a result of the decision processing, by the calculation device 101H1 described below. The restriction processes are described below in detail.

The output processing part 101F5 performs processing for outputting data from the remote KVM apparatus 101 to an external device by the calculation device 101H1 described below, each I/F, and a control apparatus (not shown) of each apparatus.

The output processing part 101F5 includes an image output part 101F51 and a restriction signal output part 101F52. The output data includes a signal, which is output by the output processing part 101F5 and is transmitted from the remote KVM apparatus 101 to the operator terminal 100 or the manufacturing apparatus 102.

The image output part 101F51 outputs an image by the calculation device 101H1 described below, a network I/F 101H4 described below, or an image output I/F 101H8 described below. When the restriction process has been performed upon an image, the image output part 101F51 outputs a restriction-processed image. For example, the image output part 101F51 transmits image data to the operator terminal 100 through the network 200 using the network I/F 101H4 described below. Further, the image output part 101F51 outputs data to an output apparatus, such as a display 101H81 connected to the image output I/F 101H8 described below.

The restriction signal output part 101F52 outputs a control signal with the restriction process performed, by an output connector 101H6 and the calculation device 101H1 described below. For example, when the restriction process is performed upon a control signal input from the operator terminal 100 through the network 200, the restriction signal output part 101F52 outputs the restriction-processed control signal to the manufacturing apparatus 102.

Further, the output processing part 101F5 may convert data into a form readable by an output destination, as a pre-processing of the outputting process. For example, the output processing part may perform D/A conversion, RGB2YCC conversion, etc. Also, the output processing part 101F5 may perform processing of adding the header data for transmission through a network, an encryption processing, a compressing processing, or an encoding processing.

### Hardware Configuration of Remote KVM Apparatus

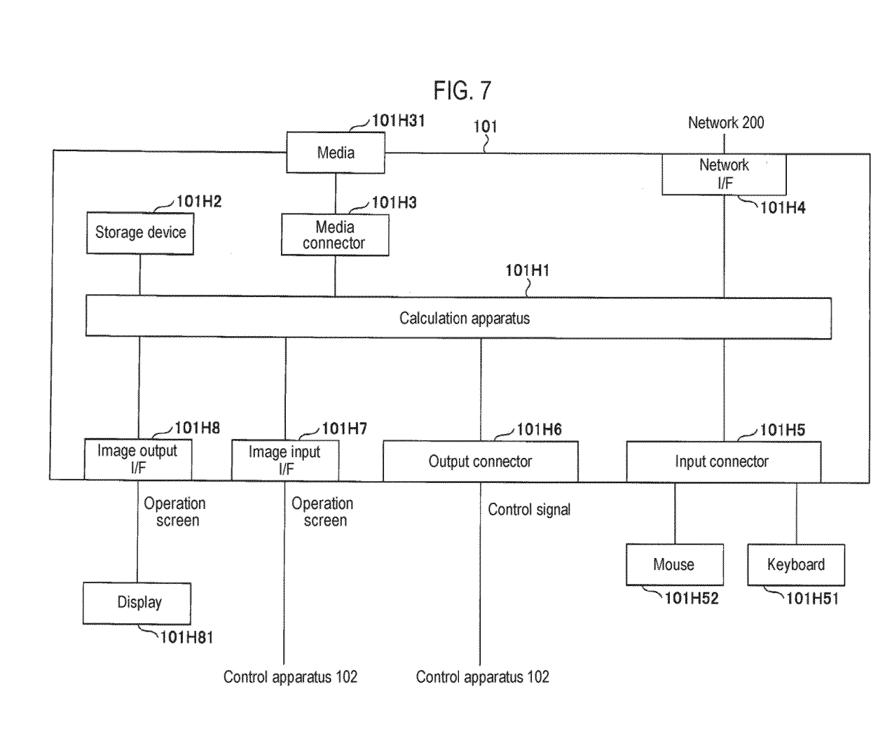

FIG. 7 is a block diagram for describing an example of a hardware configuration of a remote KVM apparatus according to an embodiment of the present disclosure.

The remote KVM apparatus 101 includes a calculation device 101H1, a storage device 101H2, a media connector 101H3, a network I/F 101H4, an input connector 101H5, an output connector 101H6, an image input I/F 101H7, and an image output I/F 101H8.

The calculation device 101H1 is configured with an Integrated Circuit (IC) performing various calculations and controls, a control apparatus, and a peripheral circuit. The calculation device 101H1 may be implemented by, for example, an FPGA, CPLD, ASIC, DSP, or System in a Package (SiP). The calculation device 101H1 may be configured with a plurality of ICs or a plurality of cores.

The storage device 101H2 is a storage device configured to store information, such as data used in an arithmetic operation by the calculation device 101H1, and is a so-called memory. The storage device 101H2 is configured with, for example, a Double-Data-Rate Synchronous Dynamic Access Memory (DDR-SDRAM) or a Static Random Access Memory (SRAM). The storage device 101H2 may have a peripheral circuit, such as a so-called arbitration circuit for adjusting timing or a wrapper circuit for converting a bit width.

The media connector 101H3 is an interface configured to electrically access a media 101H31, which is a recording media, and input or output information such as a file or data to or from the media 101H31. The media connector 101H3 has a connection terminal, such as a socket or a connection pin, corresponding to the media 101H31. Also, the media connector 101H3 has an IC (not shown) having a processing circuit for processing a signal input or output through the connection terminal.

The media 101H31 may be a flash memory, such as SD™ card, compact flash™ or the like. The media connector 101H3 may be a USB connector, and the media 101H31 may be a USB memory.

The inputting or outputting of information is not limited to a scheme using a storage medium. For example, information, such as a file, may be stored in a file server (not shown) connected to the network 200 by the network I/F 101H4 described below, and the remote KVM apparatus 101 may input or output information according to a scheme that does not require a storage medium acquiring information through the network 200.

The network I/F 101H4 is an interface for connecting to the network 200 to transmit or receive information, such ES data. to or from another apparatus. The network I/F 101H4 includes, for example, an RJ-45 connector corresponding to a LAN, and an IC having a processing circuit. The network I/F 101H4 receives control signals for operating the operation terminal through the network 200 and the manufacturing apparatus 102 from the operator terminal 100, and outputs an image signal to the operator terminal 100 based on an operation screen of the manufacturing apparatus 102. The network I/F 101H4 is not limited to a wired manner. For example, the network I/F 101H4 may have an antenna and a processing circuit for a wireless LAN and may be implemented by a wireless LAN.

The input connector 101H5 is an interface for accessing an input apparatus. The input connector 101H5 includes, for example, a USB connector or a PS/2. The input connector 101H5 has an IC having a processing circuit. The input connector 101H5 is connected to an input apparatus, such as a keyboard 101H51 or a mouse 101H52. The operator of the manufacturing apparatus 102 inputs an instruction for operating the manufacturing apparatus 102 through a GUI in the operation screen by the input apparatus. The input connector 101H5 generates output data based on the input instruction, and the output connector 101H6 described below outputs a control signal based on the output data to the manufacturing apparatus 102. The input connector 101H5 is not limited to a connector for a wired circuit. For example, the input connector 101H5 may have an antenna, and a processing circuit for performing processing according to a standard, and may be implemented for a wireless circuit, such as Bluetooth™. The input apparatus may be a pointing device, such as a pen tablet.

The output connector 101H6 is an interface for connection to the manufacturing apparatus 102 to output a control signal based on the output data, to the manufacturing apparatus 102. The output connector 101H6 includes, for example, an RS232-C connector.

The image input I/F 101H7 is an interface for connection to the manufacturing apparatus 102 to receive an image signal based on the operation screen from the manufacturing apparatus 102.

The image output I/F 101F8 is an interface connected to an output apparatus, such as the display 101H81, to output the operation screen input to the image input I/F 101H7, to the display 101H81. The output apparatus may be a projecting device, such as a projector, instead of the display 101H81.

The input apparatus connected to the input connector I/F 101H5 and the output apparatus connected to the image output I/F 101H8 may be an apparatus having an input apparatus and an output apparatus integrally formed therein, that is, a so-called touch panel.

Further, the remote KVM apparatus 101 may have a connector (not shown) and allow an input of a so-called interlock signal. For example, when an interlock signal is input, the remote KVM apparatus 101 may perform processing for interrupting the remote control from the operator terminal 100. The interlocking may be implemented by installing a switch (now shown) in the remote KVM apparatus 101 and turning on or off the switch.

### Entire Process

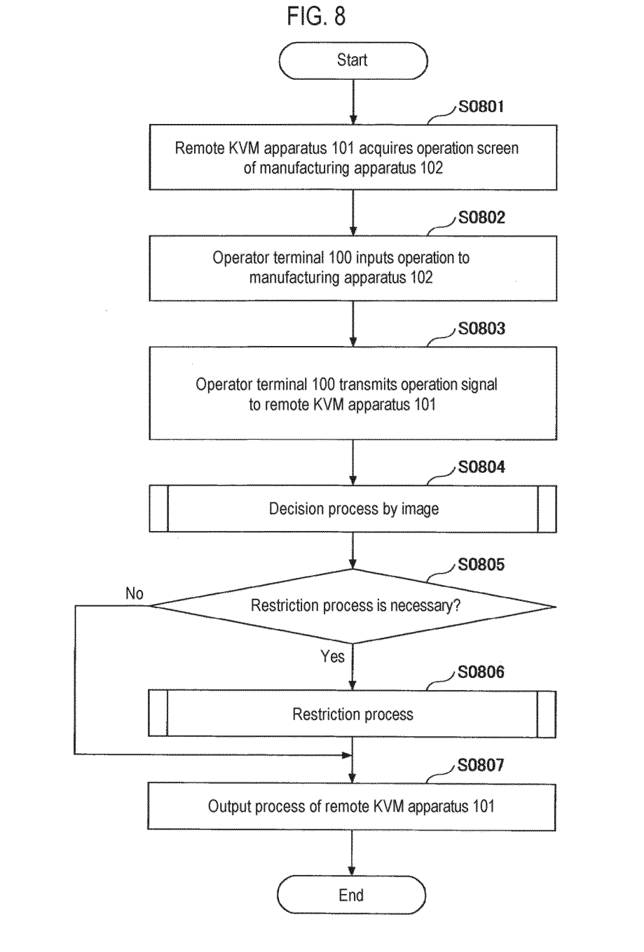

FIG. 8 is a flowchart for describing an example of an entire process by an information processing system according to an embodiment of the present disclosure.

In step S0801, the remote KVM apparatus 101 of FIG. 1 acquires an operation screen from the manufacturing apparatus 102 of FIG. 1. The operator terminal 100 of FIG. 1 acquires the operation screen, which the remote KVM apparatus 101 of FIG. 1 has acquired, from the remote KVM apparatus 101 of FIG. 1.

In step S0802, the operator inputs, to the operator terminal 100 of FIG. 1, an operation for causing the manufacturing apparatus 102 of FIG. 1 to perform a predetermined operation.

In step S0803, the operator terminal 100 of FIG. 1 transmits a control signal corresponding to an operation input by the operator in step S0802, to the remote KVM apparatus 101 of FIG. 1. The transmitted control signal is input to the remote KVM apparatus 101 of FIG. 1 by the input processing part 101F1 of the remote KVM apparatus 101 of FIG. 1 to generate input data.

In step S0804, the remote KVM apparatus 101 of FIG. 1 performs a decision process to determine whether to perform the restriction process described below, based on the operation screen acquired in step S0801 and the restriction data stored in the storage part 101F2 of the remote KVM apparatus 101 of FIG. 1. The decision process will be described later in detail.

In step S0805, the remote KVM apparatus 101 of FIG. 1 determines whether to perform the restriction process, based on a result of the decision process in step S0804. When the restriction process is determined to be necessary (“Yes” in step S0805), the process proceeds to step S0806 in which the restriction process described below is performed. When the restriction process is determined to be unnecessary (“No” in step S0805), the process proceeds to step S0807.

In step S0806, the remote KVM apparatus 101 of FIG. 1 performs the restriction process, which will be described later in detail, with respect to the operation screen acquired at step S0801 or the control signal input at step S0802.

All or a part of the processes may be distributed, through the network, to and performed by a plurality of hardware resources.

In step S0805, the remote KVM apparatus 101 of FIG. 1 determines whether to perform the restriction process, based on a result of the decision process in step S0804. When the restriction process is determined to be necessary (“Yes” in step S0805), the entire process proceeds to step S0806 in which the restriction process described below is performed. Mien the restriction process is determined to be unnecessary (“No” in step S0805), the entire process proceeds to step S0807.

In step S0806, the remote KVM apparatus 101 of FIG. 1 performs the restriction process described below in detail, with respect to the operation screen acquired in step S0801 or the control signal input in step S0802.

All or a part of the processes may be distributed, through the network, to and performed by a plurality of hardware resources.

### Decision Process

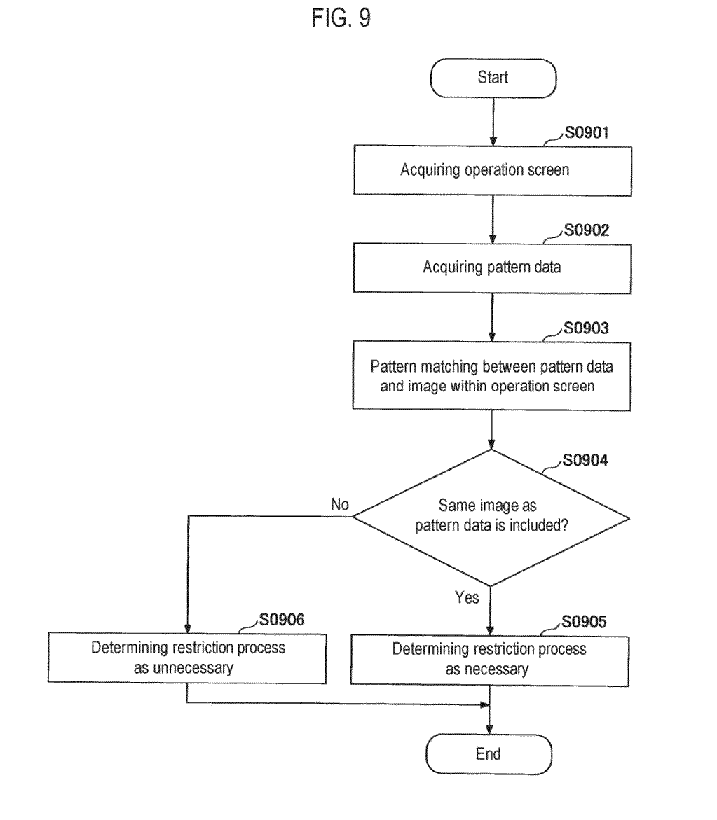

FIG. 9 is a flowchart for describing an example of a decision process according to an embodiment of the present disclosure.

The decision process corresponds to the process in step S0804 of FIG. 8. The decision process is performed by the decision processing part 101F41 of FIG. 6.

In step S0901, the decision processing part 101F41 of FIG. 6 acquires the operation screen, which has been acquired in step S0801 of FIG. 8, from the image input part 101F11 of FIG. 6.

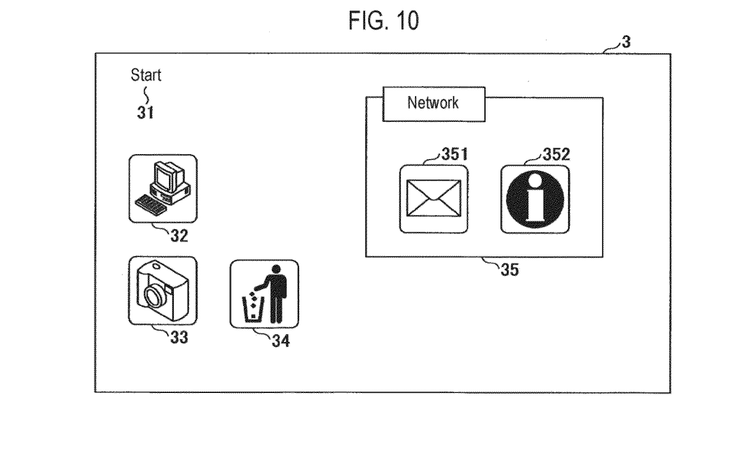

FIG. 10 is a view for describing an example of an operation screen according to an embodiment of the present disclosure. For description, the operation screen is described using, as an example, a so-called desktop screen used in a PC. The operation screen is not limited to the screen for the PC. For example, a screen for operating an apparatus, such as a manufacturing apparatus, may be used as the operation screen.

The operation screen is, for example, a desktop screen 3. The following description is based on an example in which the operation screen is the desktop screen 3.

The desktop screen 3 includes, for example, a title text 31, a terminal operation icon 32, a camera application soft icon 33, a data deletion icon 34, and a network group 35. The network group 35 is a window in which the same types of icons, for example, a mail application soft icon 351 and a network use application soft icon 352, are grouped.

In step S0902, the decision processing part 101F41 of FIG. 6 acquires, as the restriction data, the same image data as the title text 31 from the restriction data input part 101F12 of FIG. 6. The restriction data is, for example, pattern data. The restriction data stored in the media 101H31 is acquired and is stored in the storage part 101F2. The pattern data is, for example, image data of the title text 31.

The title text 31 is data indicating the state of the manufacturing apparatus 102 having transmitted to the operation screen. For example, in the case of FIG. 10, the title text 31 indicates that the manufacturing apparatus 102 is in a state of start. The following description uses as an example having the operation screen in the case of FIG. 10, wherein the restriction data is image data of “start” displayed in the title text 31 and the image data of “start” is stored in the storage part 101F2.

In step S0903, the decision processing part 101F41 of FIG. 6 performs a process, a so-called pattern matching process, of determining whether an image identical to the “start” image data exists in the image data of FIG. 10.

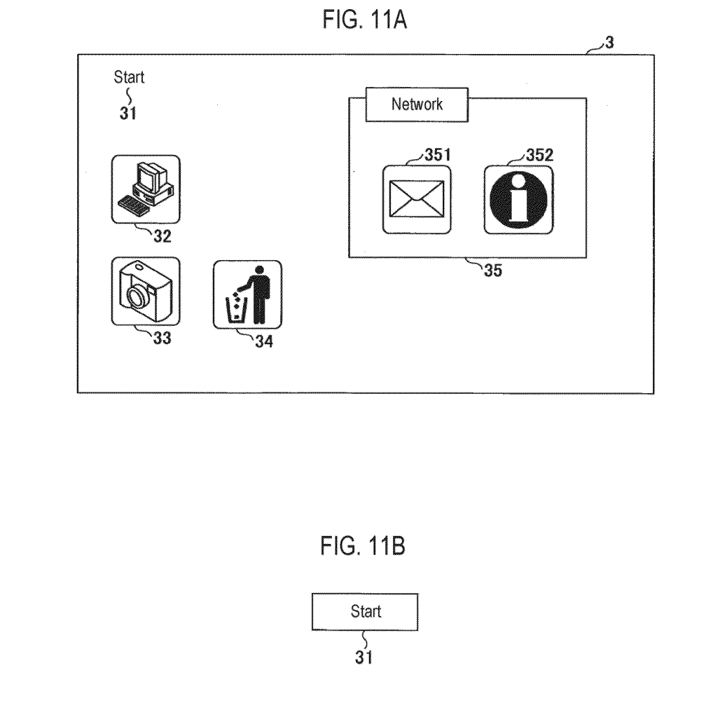

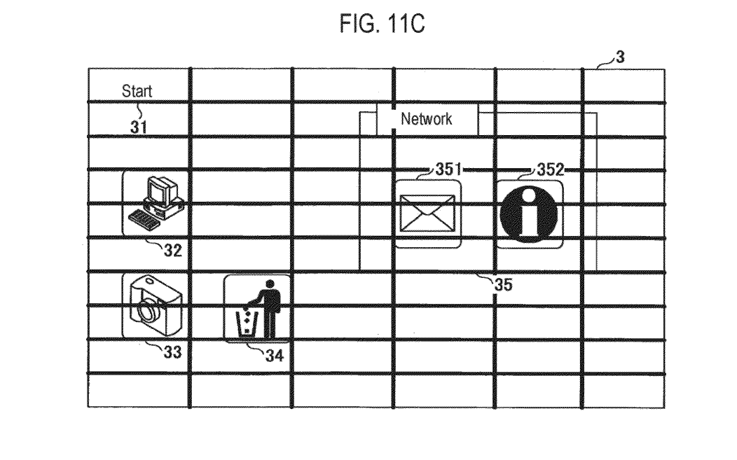

FIGS. 11A to 11C are views for describing an example of a pattern matching process according to an embodiment of the present disclosure.

The pattern matching process is implemented by an algorithm, such as a so-called template matching method for evaluating whether two images are similar to each other. The algorithm includes a so-called Sum of Squared Difference (SSD) or a Sum of Absolute Difference (SAD), which can be easily built into a logical circuit. As the algorithm. Normalized Cross Correlation (NCC) or Zero-mean Normalized Cross Correlation (ZNCC) may be used to be robust against a change in the luminance or brightness. Further, in order to achieve a correlation of a high precision, the algorithm may be a Phase-Only Correlation (POC).

FIG. 11A illustrates an example of an image to be subjected to a pattern matching process. The image to be subjected to the pattern matching process is, for example, the desktop screen 3 illustrated in FIG. 10.

FIG. 11B illustrates an example of a template image. The template image is an image stored in the storage part 101F2 arid is the “start” image data which is the same as the title text 31. FIG. 11C illustrates an example of a state in which an image to be subjected to a pattern matching process has been divided into template images.

In the pattern matching process, for example, the desktop screen 3 of FIG. 11A is divided into image areas each having the same area as that of the template image of FIG. 11B, and it is determined based on whether each divided area is identical to the template image. In the decision, for example, when the sum of luminance values of all pixels configuring each image area is identical to the sum of those of the template image, or when a difference between the two sums is equal to or less than a predetermined value, it is determined that the two images are the same image. When one or more images among the entire images are determined to be the same image, the decision processing part 101F41 of FIG. 6 determines that the desktop screen 3 includes the template image.

Further, the decision may be made using a value indicating colors, for example, red, green, or blue, instead of the luminance value. Further, the decision may be performed using another value, such as an average value, which can be calculated by a statistic process, instead of the totals.

Further, the pattern matching process is not limited to the template matching method using an image. For example, character recognition may be used for the pattern matching process for the image data of FIG. 10. The pattern matching process using the character recognition may include, for example, a process of storing the text data of “start” in the storage part 101F2 and determining, through a character recognition process, whether the text data is identical to a character included in the image data of FIG. 10.

Further, the pattern matching process may be performed by a combination of the template matching using an image and the template matching using the character recognition.

In step S0904, the decision processing part 101F41 of FIG. 6 determines, based on a result of the pattern matching in step S0903, whether the same image as the predetermined pattern data is included. When it is determined in step S0903 that the desktop screen 3 includes the template image (“Yes” in step S0904), the decision processing part 101F41 of FIG. 6 proceeds to step S0905 in which the restriction process described below is determined to be necessary. When it is determined in step S0903 that the desktop screen 3 does not include the template image (“No” in step S0904), the decision processing part 101F41 of FIG. 6 proceeds to step S0906 and determines that the restriction process described below is unnecessary.

In step S0904, the decision processing part 101F41 of FIG. 6 acquires setting data.

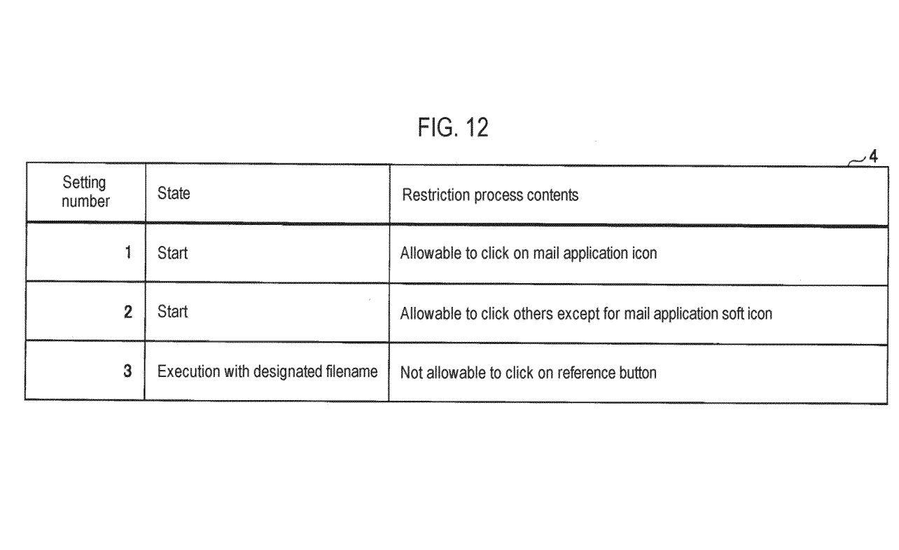

FIG. 12 illustrates a Table for describing an example of the setting data according to an embodiment of the present disclosure.

As noted from the setting data 4 of FIG. 12, the setting data is data to be input by associating a restriction process content performed by a restriction process with a state for performing the restriction process content of the restriction process. The decision processing part 101F41 of FIG. 6 acquires the setting data 4 stored in the media 101H31 and stores the acquired data in the storage part 101F2.

For example, in a state where the desktop screen 3 of the operation screen is in the state of “start” illustrated in FIG. 10, when a manager of the manufacturing apparatus 102 sets as allowable to click on the mail application soft icon 351”, the setting date is set such that the “setting number” shown in the setting data 4 of FIG. 12 becomes “1”. The setting is input to the setting data 4 by associating a state of performing the restriction process with a restriction process content, like that the state is “start” and the restriction process content is that “allowable to click on the mail application soft icon 351”, when the “setting number” of the setting data 4 is “1”. That is, in this case, the decision processing part 101F41 of FIG. 6 determines that it is in the state of “start”, based on the desktop screen 3 illustrated in FIG. 10.

Thereafter, the decision processing part 101F41 of FIG. 6 determines that the restriction process is necessary in the case of the state of “start” and determines that the restriction process is unnecessary in the other cases excepting the case of the state of “start”. Therefore, in step S0904, the decision processing part 101F41 of FIG. 6 determines that the restriction process is necessary when it is determined that the template image of “start” is included in the desktop screen 3.

Further, multiple restriction process contents may be set for one state, like the cases where the setting number of the setting data 4 of FIG. 12 is 1 and where the setting number is 2.

Further, the restriction process contents may be configured for multiple states, like cases where the setting number of the setting data 4 of FIG. 12 is 1 and where the setting number is 3.

Although the “state” and the “restriction process content” are set for the “setting number” in FIG. 12, the setting content may be changed according to the attribute of the operator. For example, the setting content of the restriction process may be changed according to whether the operator is a manager or an ordinary user. In the case of the remote control of a semiconductor manufacturing apparatus, the setting content of the restriction process may be properly changed according to whether the operator is a maintenance repair worker, a process engineer, or a process operator. In this event, the attribute of the operator may be determined based on an ID for log-in to the operator terminal Since the setting content can be changed according to the state of the apparatus or the attribute of the operator as described above, the present disclosure can properly secure the degree of freedom for the operation while securing the safety in the remote control.

By the pattern matching process, the remote KVM apparatus 101 of FIG. 1 can determine the state of the manufacturing apparatus 102 from the image data of the operation screen.

### Restriction Process

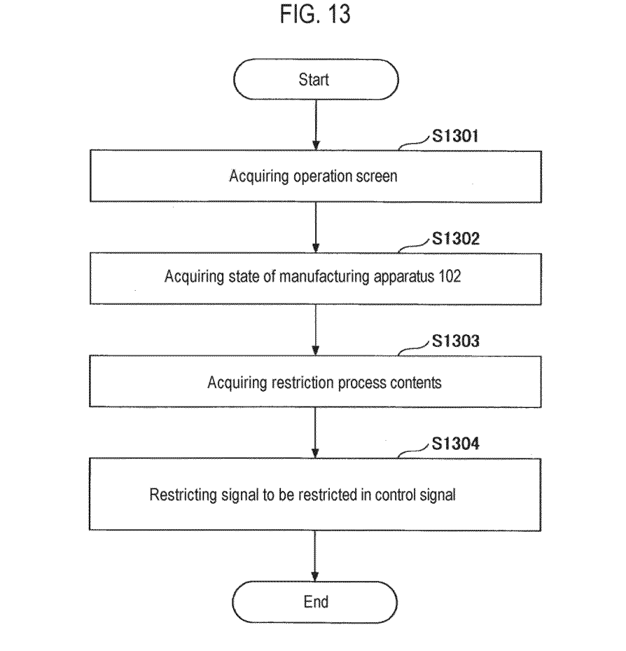

FIG. 13 is a flowchart for describing an example of a restriction process of a first embodiment according to an embodiment of the present disclosure.

The restriction process is a process performed when it is determined that the restriction process is necessary in the decision process, which is a process of the previous stage, that is, in the case of “Yes” in step S0805 of FIG. 8.

By the restriction process, while an operator remotely controls the manufacturing apparatus 102, the remote KVM apparatus 101 of FIG. 1 can arrange a restriction for preventing a predetermined process from being performed, or invalidating the predetermined process, with respect to the remote control.

In step S1301, the restriction processing part 101F4 of FIG. 6 acquires a desktop screen 3, which is an operation screen.

In step S1302, the restriction processing part 101F4 of FIG. 6 acquires a state of the manufacturing apparatus 102, which has been determined in the decision process in step S0804.

In step S1303, the restriction processing part 101F4 of FIG. 6 acquires a restriction process content from the setting data 4 acquired in the decision process of FIG. 8.

In step S1304, the restriction processing part 101F4 of FIG. 6 performs a process of restricting a signal to be subjected to the restriction process based on the control signal. The process of restricting the signal includes, for example, a process of eliminating a target signal. When the operator inputs a process for the restriction process to the setting data 4, the restriction processing part 101F4 of FIG. 6 restricts a control signal corresponding to the process for the restriction process from the control signal output to the manufacturing apparatus 102. That is, when an operation to be restricted by the restriction process is input from the operator terminal 100, the remote KVM apparatus 101 does not output the input operation to the manufacturing apparatus 102.

For example, in the case of the setting data 4 of FIG. 12, when it has been determined in the decision process of step S0804 that the state of the manufacturing apparatus 102 is “start” and the restriction of the setting numbers “1” and “2” is required from the setting data 4, the remote KVM apparatus 101 restricts the other operations, as an object to be restricted by the restriction process, excepting the clicking of the mail application soft icon 351 in the operation of the operator terminal 100 by the operator. For example, in the case of the setting data 4 of FIG. 12, and when the operator has performed an operation of clicking the camera application soft icon 33 other than the mail application soft icon 351, the restriction processing part 101F4 of FIG. 6 restricts a control signal based on the operation of clicking the camera application soft icon 33 in step S1304.

In the determination on whether it is a target of the restriction process, the remote KVM apparatus 101 has, for example, coordinate data of an area to be a target of the restriction process and an area not to be a target of the restriction process in a screen thereof. The remote KVM apparatus 101 determines whether an operation of an icon is a restricted operation, by determining, from the coordinate data, whether an operation input from the operator terminal 100 is an operation performed in the area to be a target of the restriction process or an operation performed in the area not to be a target of the restriction process.

By restricting the control signal corresponding to the operation to be a target of the restriction process, the remote KVM apparatus 101 of FIG. 1 can transmit a control signal based on a safe operation to the manufacturing apparatus 102 and thus can perform an operation securing the safety in the remote control of the apparatus.

Further, the operation to be a target of the restriction in step S1304 is not limited to the click-based input. A control signal output from the output connector 101H6 of FIG. 7 to the manufacturing apparatus 102 may also be restricted. For example, the text data input by the keyboard 100H51 of FIG. 3 or a control signal instruction of RS232C output from the output connector 101H6 of FIG. 7 to the manufacturing apparatus 102 may also be restricted.

When a process of restricting an operation is performed in step S1304, the restricted process may be notified to the operator.

Hereinafter, a case that is the setting data 4 of FIG. 12 and which the operator has performed an operation of clicking the camera application soft icon 33 other than the mail application soft icon 351 will be described as an example.

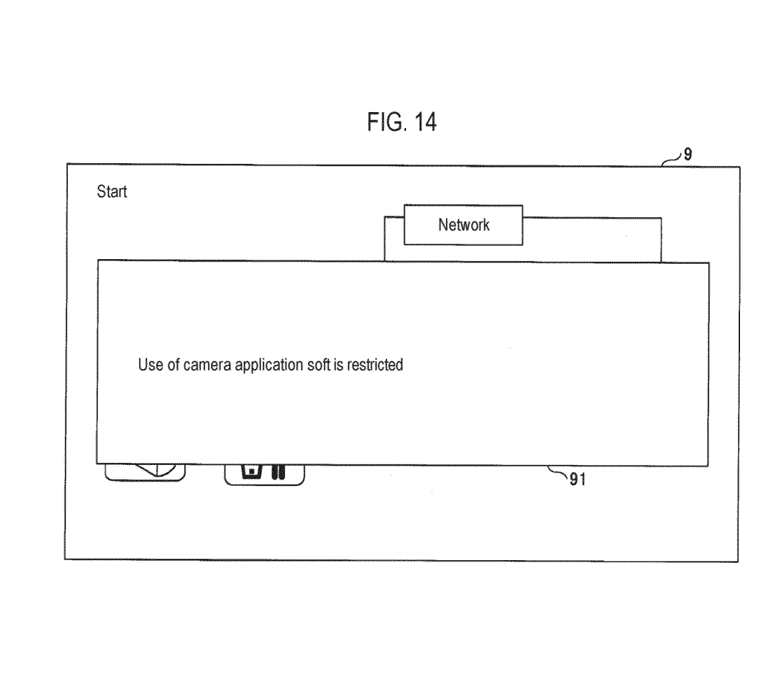

FIG. 14 is a view for describing an example of a restriction process of the first embodiment according to an embodiment of the present disclosure.

FIG. 14 illustrates an example of a notification using a message box to an operator. In step S1304, when a process of restricting a control signal corresponding to an operation of clicking the camera application soft icon 33 has been performed, the remote KVM apparatus 101 of FIG. 1 transmits a desktop screen 9 for notifying the operator illustrated in FIG. 14 to the operator terminal 100.

The desktop screen 9 for notifying the operator is generated by overlapping a message box 91, which notifies a fact that the operation of clicking the camera application soft icon 33 has been restricted, on the desktop screen 3 of FIG. 10.

By the message box 91, the operator can understand the operation to be restricted.

Further, the method for notifying the operator is not limited to the notification using the message box 91. For example, a process of outputting a warning sound to the operator terminal 100 or a process using another pop-up GUI may be performed.

The restriction data stored in the storage part 101F2 of FIG. 6 is not limited to data specifying a target of the restriction process. For example, data, which is not to be a target of the restriction process, may be memorized, and other parts except for the memorized data are restriction-processed.

The restriction data stored in the storage part 101F2 of FIG. 6 is not limited to image data. The restriction data may be, for example, text data storing a character or symbol. The restriction data may be, for example, coordinate data for indicating a predetermined range, size, position, or layout of a screen. The restriction data may be marker data, such as a QR code™ or bar code. The restriction data may be, for example, data indicating a lay out or a window-shape for specifying an error message box.

By the remote KVM apparatus 101, the operator can operate an apparatus located at a physically remote place from the operator. For example, the semiconductor manufacturing apparatus is installed at a place having very few particles floating in the air, i.e., a so-called clean room. In the case of operating a semiconductor manufacturing apparatus, the operator has to go through tasks of clothes changing, hand washing, and air shower in order to enter the clean room. Further, since the operator working in the clean room may serve as a contamination source by his or her action, sweating, or exhaling, it is preferable to reduce the number of the operators entering the clean room and the number of times of entrance. By the remote KVM apparatus 101, the operator can operate a semiconductor manufacturing apparatus without entering the clean room.

The restriction process and the decision process are performed by the remote KVM apparatus 101. Therefore, the necessity for the operator to repair the operator terminal 100 and the manufacturing apparatus 102, for example, to install new software therein, is reduced. Therefore, by the remote KVM apparatus 101, the present disclosure can reduce repairs of a controlling apparatus and a controlled device, and thus can easily construct a system. Further, without repairs, the system can be constructed.

Further, the control process is a process capable of restricting the operator's operation. Since it is possible to recognize the state of the apparatus from the operation screen of the manufacturing apparatus 102, the remote KVM apparatus 101 can restrict a control signal relating to a remote operation, which may have a safety problem according to the state of the apparatus, from being transferred to the manufacturing apparatus 102. For example, when the manufacturing apparatus 102 is a semiconductor manufacturing apparatus, since the operator of the operator terminal 100 is remotely located, it may be dangerous for the operator to operate the manufacturing apparatus without information on the surrounding situation of the manufacturing apparatus 102 while the maintenance of the manufacturing apparatus 102 are being performed. The safety can be enhanced by restricting an operation considered to be dangerous according to the state of the manufacturing apparatus 102 in the process of operating the manufacturing apparatus 102 by remote control. Therefore, by the remote KVM apparatus 101, the present disclosure can achieve remote control with secured safety.

### Second Embodiment

As the second embodiment, an information processing apparatus and an information processing system according to an embodiment of the present disclosure will be described hereinafter. The information processing system according to the second embodiment uses the information processing system 1 of FIG. 1 used in the first embodiment. Therefore, a description of the information processing system 1 of FIG. 1 is omitted here.

The second embodiment will be described based on an example in which the operator terminal 100 used in the first embodiment is used as a first information processing device. Therefore, a description of the operator terminal 100 is omitted here.

The second embodiment will be described based on an example in which the manufacturing apparatus 102 used in the first embodiment is used as a second information processing device. Therefore, a description of the manufacturing apparatus 102 is omitted here.

The second embodiment will be described based on an example in which the remote KVM apparatus 101 used in the first embodiment is used as an information processing apparatus. Therefore, description of the remove KVM apparatus 101 is omitted here.

The entire process according to the second embodiment is the same as the entire process of FIG. 8 performed according to the first embodiment. The second embodiment is different from the first embodiment in the contents of the decision process using an image in step S0804 and the restriction process in step S0806.

### Decision Process of Second Embodiment

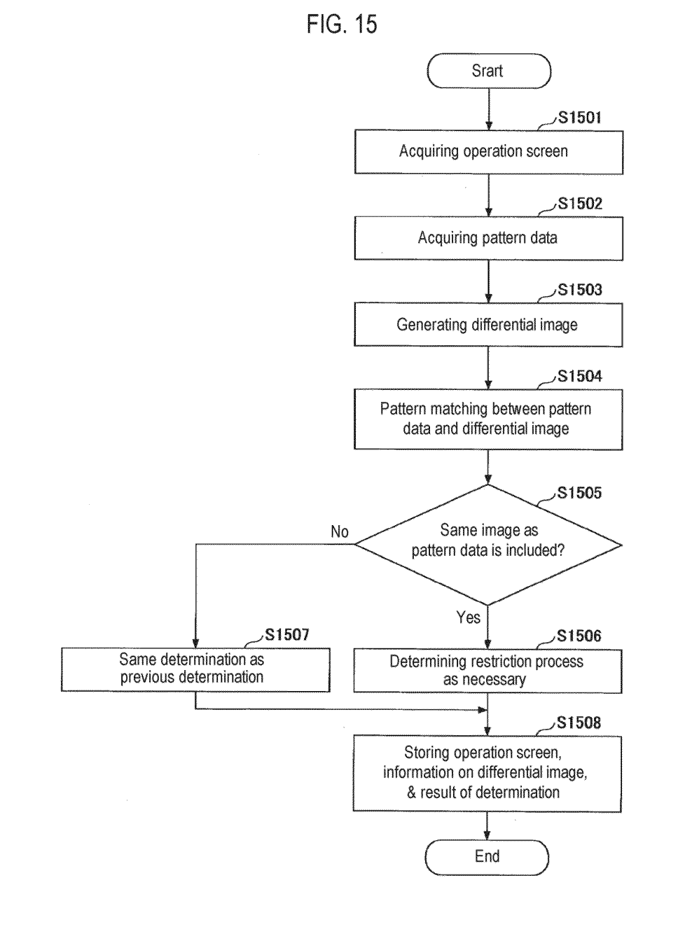

FIG. 15 is a flowchart for describing an example of a decision process of a second embodiment according to an embodiment of the present disclosure.

As illustrated in FIG. 15, in the decision process of the second embodiment, in steps S1501 and S1502, the same processes as those in steps S0901 and S0902 of FIG. 9 of the first embodiment are performed, and the decision processing part 101F41 of FIG. 6 acquires an operation screen and pattern data.

In step S1503, the decision processing part 101F41 of FIG. 6 generates a differential image. The differential image is an image including an image area of a different part obtained through comparison between an operation screen with a previous decision process performed and an operation screen for a current decision process. The operation screen of the previous decision process is acquired, for example, by reading image data stored in the storage part 101F2 of FIG. 6, in step S1508 of the previous decision process described below.

The first decision process, which no image data is stored in the storage part 101F2 of FIG. 6, is performed through another decision process, which does not use data stored in the storage part 101F2 of FIG. 6, for example, the decision process of the first embodiment. The following description will be made based on an example in which the decision process of the first embodiment is performed as the first decision process and various data of previous decision processes are stored in the storage part 101F2 of FIG. 6 in step S1508.

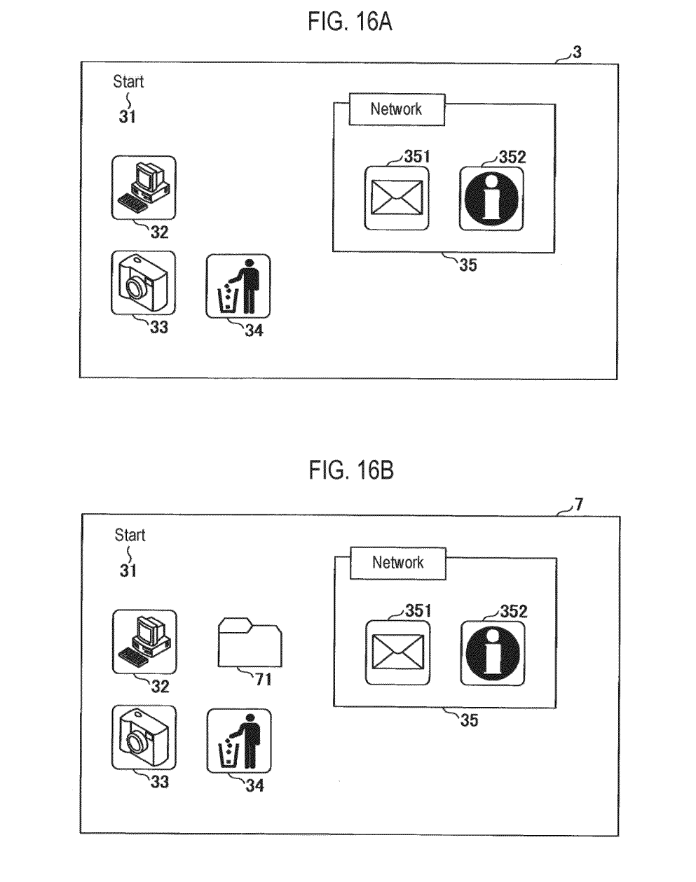

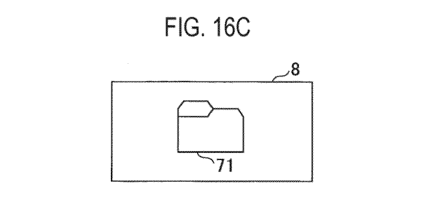

FIGS. 16A to 16C are views for describing an example of a differential image and a differential image generating method of the second embodiment according to an embodiment of the present disclosure.

FIG. 16A illustrates an example of an operation screen of a previous decision process. FIG. 16A corresponds to a case where the operation screen of the previous decision process is the desktop screen 3 illustrated in FIG. 10.

FIG. 16B illustrates an example of an operation screen of a current decision process. FIG. 16B is a view illustrating a desktop screen 7 after changing the desktop screen 3 of FIG. 16A, which is the operation screen of the previous decision process, by adding a folder 71 thereto.

Hereinafter, the following description will be made based on an example in which the operation screen of the previous decision process is the desktop screen 3 illustrated in FIG. 16A and the operation screen of the current decision process is the after-change desktop screen 7 of FIG. 16B.

FIG. 16C illustrates an example of a differential image generated in step S1503. The differential image 8 is an image obtained by comparing the desktop screen 3 of FIG. 16A and the after-change desktop screen 7 of FIG. 16B and extracting a different part therebetween. Since the desktop screen 3 of FIG. 16A and the after-change desktop screen 7 of FIG. 16B are different from each other in that the folder 71 has been added to the after-change desktop screen 7, FIG. 16C is an image of the folder 71.

In relation to steps S1504 to S1507, the decision processing part 101F41 of FIG. 6 performs the processes of steps S0903 to S0906 of FIG. 9 of the first embodiment on the changed entire desktop screen 7 in the first embodiment. In contrast, in steps S1504 to S1507, the decision processing part 101F41 of FIG. 6 performs the processes upon the differential image 8.

Specifically, in steps S1504 to S1507, the decision processing part 101F41 of FIG. 6 perform the decision process about whether or not a pattern matching process and a restriction process are necessary for the differential image 8 having a small image size with respect to for the after-change desktop screen 7. Since the decision process about whether or not the pattern matching process and the restriction process are necessary is performed for the small image, a quantity of calculation is small, so that the process can be performed at a high speed.

In step S1504, in the case of the differential image 8, like the first embodiment, the decision processing part 101F41 of FIG. 6 determines, by pattern matching, whether the differential image 8 includes characters of “start”.

In step S1505, when the differential image 8 includes characters of “start”, the decision process proceeds to step S1506 in which it is determined that the restriction process is necessary. In step S1505, when the differential image 8 does not include characters of “start”, the decision process proceeds to step S1507. Then, in order to determine whether the restriction process is necessary, the same decision as a result of a previous decision process stored in step S1508 described below is performed. The after-change desktop screen 7 has characters of “start” in the title text 31, as shown in FIG. 16B. In the previous decision process, it is determined in step S1506 that a restriction process is necessary, and a result of the determination that a restriction process is necessary is stored in the storage part 101F2 of FIG. 6. Therefore, in step S1507, a process of determining that a restriction process is necessary is performed.

In step S1508, the decision processing part 101F41 of FIG. 6 stores, in the storage part 101F2 of FIG. 6, the after-change desktop screen 7, the differential image 8, a coordinate position of the differential image 8, and a result of the determination in step S1507 that a restriction process is necessary.

### Restriction Process of Second Embodiments

The restriction process according to the second embodiment is the same as the restriction process of the first embodiment. In the restriction process of the second embodiment, as described with reference to FIG. 14, by the message, the operator can understand an operation to be restricted.

As the restriction process of the second embodiment, the restriction process in which the restriction process using the message described with reference to FIG. 14 and the mask process described below are combined may be performed. Further, in the restriction process of the second embodiment, the process of restricting a control signal of the first embodiment may be performed using differential information.

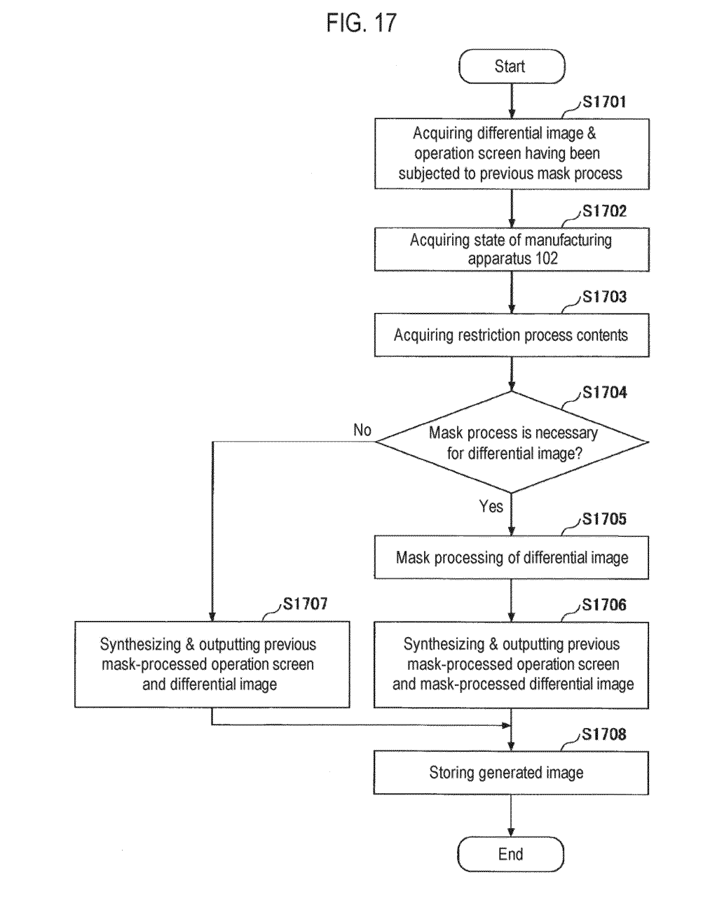

FIG. 17 is a flowchart for describing an example of a restriction process of a second embodiment according to an embodiment of the present disclosure. In the restriction process of the second embodiment, for example, a mask process described below is performed as the restriction process. Hereinafter, the restriction process of the second embodiment will be described on a basis of a mask process described below.

The mask process is a process of performing a process, such as a shading process, upon an icon which is set to be restricted in the setting data 4 of FIG. 12 to visually display that the use is restricted to the operator on a screen.

In the mask process, for example, a process, such as a shading process, is performed upon an icon set to be restricted in the setting data 4 of FIG. 12. When the operator operates in the area with the shading process performed, the restriction processing part 101F4 performs a process of restricting a control signal output to the manufacturing apparatus 102, which corresponds to the operation by the restriction processing part 101F4 of FIG. 6, and the mask process indicates that the restriction process is performed.

The mask process will be described later in detail.

In the restriction process of the second embodiment, the restriction process is performed for a differential image 8. In the restriction process of the second embodiment, an operation screen is generated by synthesizing an image obtained through the restriction process of the differential image 8 and a mask-processed operation screen generated based on the previous restriction process, and is then output.

In step S1701, the restriction processing part 101F4 of FIG. 6 acquires a differential screen and a previous mask-processed operation screen. The differential image 8 is acquired by reading data stored in the storage part 101F2 of FIG. 6 in the decision process of FIG. 15. The previous mask-processed operation screen is acquired, for example, by reading image data stored in the storage part 101F2 of FIG. 6 in step S1708 described below. The first restriction process where no image data is stored in the storage part 101F2 of FIG. 6 is performed through another restriction process, which does not use data stored in the storage part 101F2 of FIG. 6, for example, the restriction process of the first embodiment. The following description will be made based on an example in which the restriction process of the first embodiment is performed as the first restriction process and various data of previous restriction processes are stored in the storage part 101F2 of FIG. 6 in step S1708 described below.

In steps S1702 and S1703, the restriction processing part 101F4 of FIG. 6 performs the same processes as those in steps S1302 and S1303 of FIG. 13 of the first embodiment, and acquires contents of the restriction process based on the setting data 4 stored in the storage part 101F2 of FIG. 6 and the state of the manufacturing apparatus 102.

In steps S1704 to S1707, the restriction processing part 101F4 of FIG. 6 determines whether a mask process is necessary for the differential image 8 acquired in step S1701 and, performs the mask process, differently from the first embodiment.

In step S1704, the restriction processing part 101F4 of FIG. 6 determines whether a mask process is necessary for the differential image 8.

When it is determined that a mask process is necessary based on the contents of the restriction process acquired for the differential image 8 in step S1703 (“Yes” in step S1704), the restriction process proceeds to step S1705, in which the restriction processing part 101F4 of FIG. 6 performs a mask process for the differential image. When it is determined that a mask process is unnecessary based on the contents of the restriction process acquired for the differential image 8 in step S1703 (“No” in step S1704), the restriction process proceeds to step S1707, in which the restriction processing part 101F4 of FIG. 6 synthesizes the differential image and the previous mask-processed operation screen, and outputs an image generated by the synthesis.

In step S1705, the restriction processing part 101F4 of FIG. 6 performs the mask process for the differential image. When the differential image 8 is the image shown in FIG. 16C and the setting data is the setting data 4 of FIG. 12, the differential image 8 is the folder 71 as shown in FIG. 16C. Based on the setting data 4 of FIG. 12, it is determined that the folder 71 is required to be subjected to a mask process.

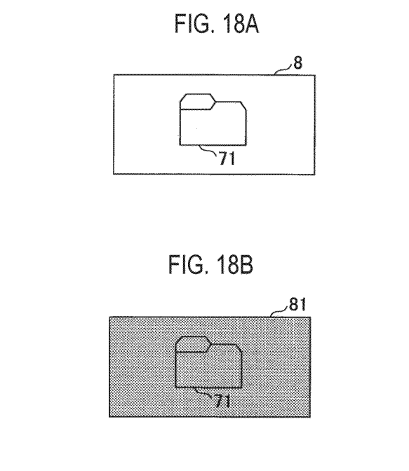

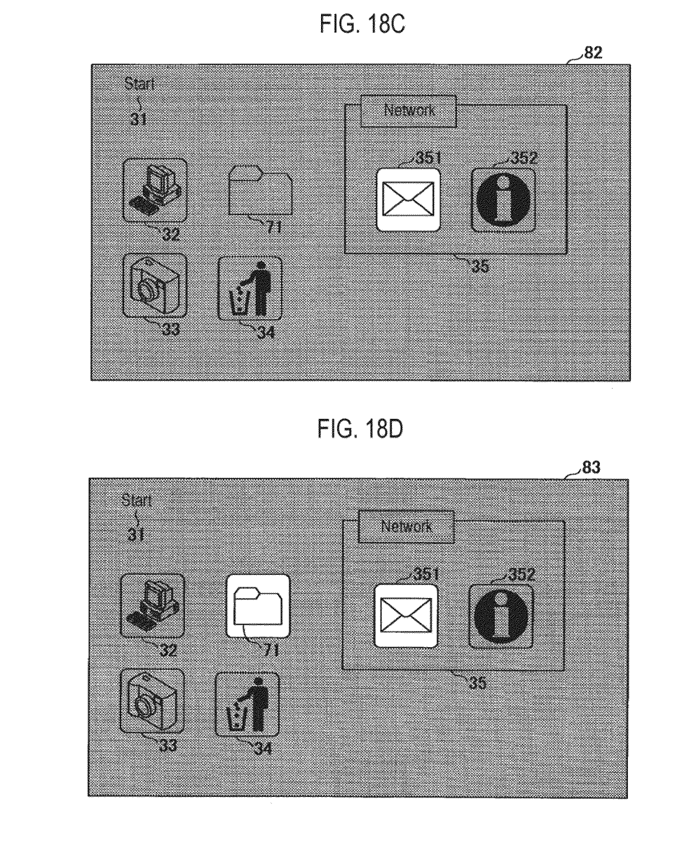

FIGS. 18A to 18D are views for describing an example of a mask process of the second embodiment according to an embodiment of the present disclosure.

FIG. 18A illustrates an example of a differential image. An image of FIG. 18A is identical to the image of FIG. 16C.

FIG. 18B illustrates an example of a mask-processed differential image. FIG. 18B illustrates a differential image 81 obtained by mask-processing the differential image 8 of FIG. 18A through a shading process, which is a mask process of step S1705.

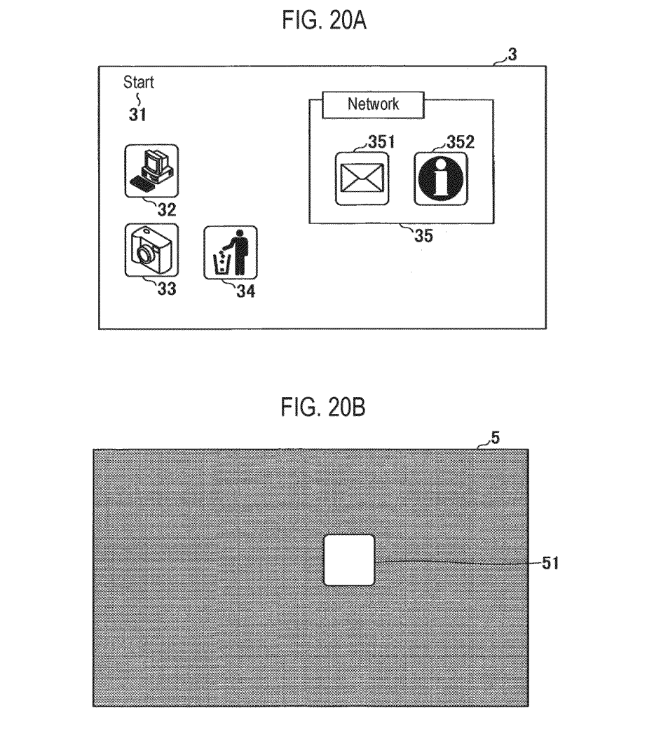

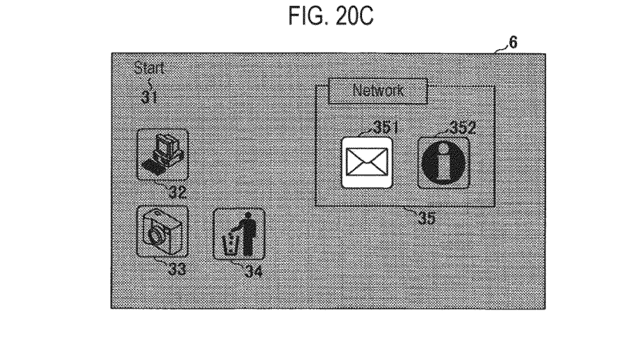

In step S1706, the restriction processing part 101F4 of FIG. 6 synthesizes the mask-processed differential image 81 and a previous mask-processed operation screen, and outputs a synthesized screen. The previous mask-processed operation screen is, for example, the mask-processed desktop screen 6 of FIG. 20C and is stored in the storage part 101F2 of FIG. 6 in step S1708 of the previous restriction process described below.

FIG. 18C illustrates an example of a desktop screen 82 generated by the synthesis.

As shown in FIG. 18C, the desktop screen 82 generated by the synthesis is generated by generating an operation screen by overlapping the mask-processed differential image 81 on the mask-processed desktop screen 6 of FIG. 20C described below by the restriction processing part 101F4 of FIG. 6.

In order to perform the synthesizing, coordinate information indicating the position, size, and range of the differential image may be stored as information relating to the differential image in step S1508 of FIG. 15 for the decision process, and may be used in step S1706 for the restriction process.

In step S1707, the restriction processing part 101F4 of FIG. 6 synthesizes, for example, the mask-processed desktop screen 6 of FIG. 20 described below and the differential image 8 of FIG. 18A, and outputs a synthesized screen.

FIG. 18D illustrates a desktop screen 83 generated through synthesis without masking differential images.

The desktop screen 83 having unmasked differential images corresponds to an image generated when the folder 71 is configured to be clickable, like the mail application soft icon 351, in the setting data 4 acquired in step S1703.

In step S1706, the desktop screen 83 having unmasked differential images is generated by synthesizing the differential image 8 and a previous mask-processed operation screen by the restriction processing part 101F4 of FIG. 6.

In step S1708, the restriction processing part 101F4 of FIG. 6 stores the desktop screen 82 generated by the synthesis in step S1706 in the storage part 101F2 of FIG. 6.

Since a target for determining whether to perform the mask process and performing the mask process is a differential image having a smaller image size than a desktop image, the restriction process of the second embodiment can be performed at a high speed due to a smaller quantity of calculation.

Although a folder is added to a desktop screen in the described example, the embodiment is not limited to this example. For example, when a pop-up window is displayed on a screen, the same differential process may be performed like the second embodiment. Specifically, when a pop-up screen indicative of a state of “execution with a designated filename” is displayed as a setting number of “3” in the setting data 4 of FIG. 12, the decision process and the restriction process may be performed upon the corresponding differential image.

In the second embodiment, the restriction process and the decision process are performed by the remote KVM apparatus 101 as in the first embodiment. Therefore, the necessity for the operator to repair the operator terminal 100 and the manufacturing apparatus 102, for example, to install new software therein, is reduced. Therefore, by the remote KVM apparatus 101, the present disclosure can reduce the number of repairs of a controlling apparatus and a controlled device, and thus can easily construct a system. Further, without repairs, the system can be constructed.

By performing the restriction process, when the remote control is performed, the remote KVM apparatus 101 can notify a dangerous operation to the operator, thereby preventing the operator from performing a dangerous operation. Therefore, by the remote KVM apparatus 101, the operator can perform an operation having a secured safety in the remote control.

### Third Embodiment

As the third embodiment, an information processing apparatus and an information processing system according to an embodiment of the present disclosure will be described hereinafter. The information processing system according to the third embodiment uses the information processing system 1 of FIG. 1 used in the first embodiment. Therefore, a description of the information processing system 1 of FIG. 1 is omitted here.

The third embodiment is described based on an example in which the operator terminal 100 used in the first embodiment is used as a first information processing device. Therefore, a description of the operator terminal 100 is omitted here.

The third embodiment is described based on an example in which the manufacturing apparatus 102 used in the first embodiment is used as a second information processing device. Therefore, a description of the manufacturing apparatus 102 is omitted here.

The third embodiment is described based on an example in which the remote KVM apparatus 101 used in the first embodiment is used as an information processing apparatus. Therefore, a description of the remove KVM apparatus 101 is omitted here.

The entire process according to the third embodiment is the same as the entire process of FIG. 8 performed according to the first embodiment. The third embodiment is different in the contents of the restriction process in step S0806.

### Restriction Process of Third Embodiments

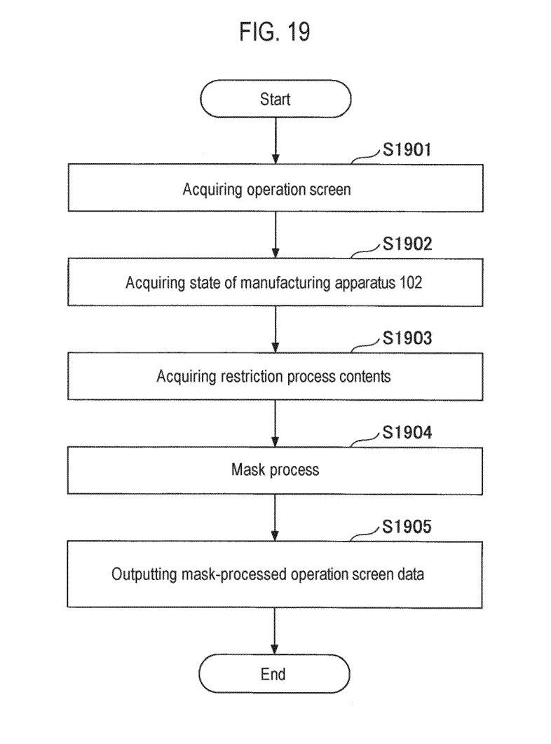

FIG. 19 is a flowchart for describing an example of a restriction process of the third embodiment according to an embodiment of the present disclosure.

The restriction process of the third embodiment of FIG. 19 is different from the restriction process of the first embodiment of FIG. 13 in that step S1304 of FIG. 13 corresponds to steps S1904 and S1905. Therefore, the processes in steps S1901 to S1903 in the restriction process of the third embodiment of FIG. 19 are the same as those in steps S1301 to S1303 in the restriction process of the first embodiment of FIG. 13, so a description thereof will be omitted. Now, it will be described on a basis on parts different from the restriction process of the first embodiment of FIG. 13.

In step S1904, the restriction processing part 101F4 of FIG. 6 performs a restriction process corresponding to the current state set in the setting data 4 of FIG. 12. Hereinafter, a case of performing a process of, when the state is “start”, of “allowable to click on the mail application soft icon 351” as a process of shading the parts except for the mail application soft icon 351 will be described.

In step S1904, the restriction processing part 101F4 of FIG. 6 performs a mask process on the other parts except for the area in which the mail application soft icon 315 is displayed, on the desktop screen 3 acquired in step S1901.

FIGS. 20A to 20C are views for describing an example of a mask process on an operation screen according to an embodiment of the present disclosure.

FIG. 20A illustrates an example of a desktop screen 3 acquired in step S1901. The acquired desktop screen 3 has the same data as the image acquired in step S0901 of FIG. 10 and FIG. 9.

FIG. 20B illustrates an example of mask data used for a mask process. The mask data 5 is image data having the same number of longitudinal and transverse pixels, that is, having the same size, as those of the image of the desktop screen 3. In the mask data 5, a clickable area 51 is configured. The clickable area 51 is an image area of penetration, which is designated in advance. When the mask data 5 is overlapped, the clickable area 51 is displayed without being masked by the overlapping image part.

FIG. 20C illustrates an example of a mask-processed desktop screen 6. The mask-processed desktop screen 6 is generated by overlapping the mask data 5 of FIG. 20B on the desktop screen 3 of FIG. 20A. By the mask process, the restriction processing part 101F4 of FIG. 6 can generate a desktop screen 6 in which the clickable area in the image of FIG. 20A, that is, the clickable area 51 designated in FIG. 20B is displayed while the other area is masked with a shade.

By FIG. 20C, the operator can understand operation contents executable by the remote control in the current state.

Further, in the restriction process of the third embodiment, it is preferable to perform multiple restriction processes in combination of the restriction process of the first embodiment.

In the restriction process, the target to be restricted is not limited to the icon. The restriction process may be performed for, for example, another kind of widget. The target to be restricted includes a GUI, such as a tab, a scroll bar, a text box, a check box, a radio button, or a window.

The mask process is not limited to the processes in FIG. 20A to FIG. 20C. For example, the mask process may not be displayed or may be invalidated.

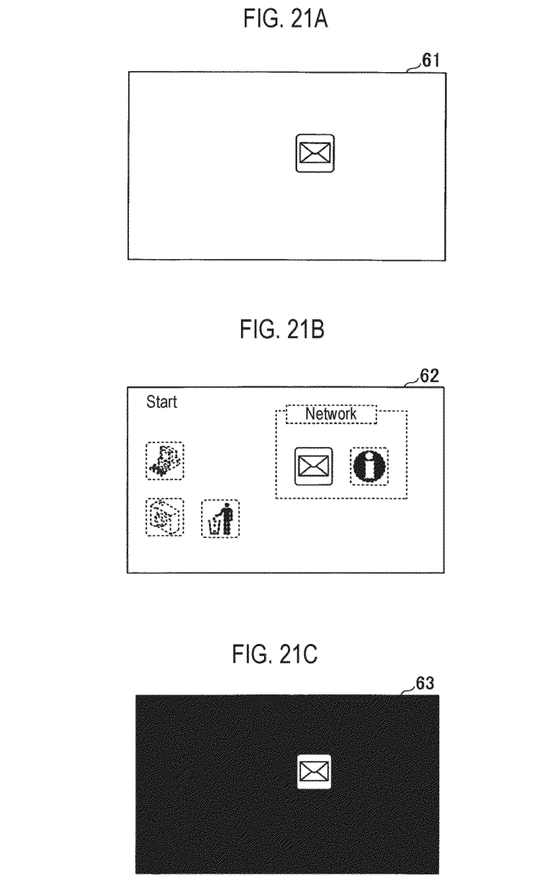

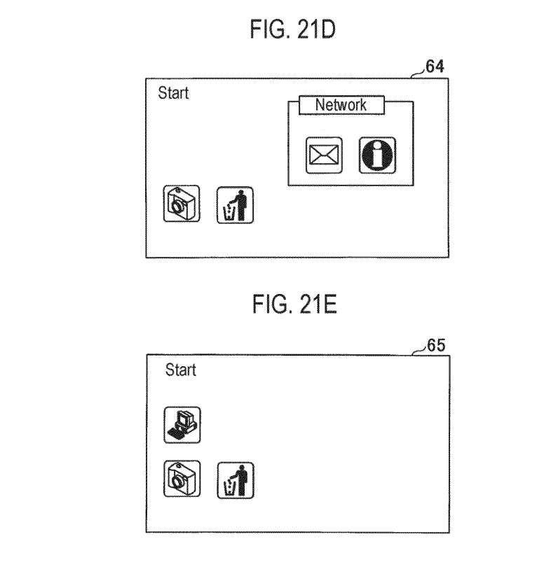

FIGS. 21A to 21E are views for describing examples of kinds of a mask process according to an embodiment of the present disclosure.

All of FIG. 21A to 21E illustrate a case in which the mask data 5 of FIG. 20B overlaps on the desktop screen 3 of FIG. 20A, as in the mask process described with reference to FIGS. 20A to 20C. The mask process performed on the other area except for the clickable area 51 in FIG. 20A to FIG. 20C is different from that in FIG. 21A to FIG. 21E.

FIG. 21A illustrates an example of a widget, which is located in the other area except for the clickable area 51 of FIG. 20B and has been subjected to a mask process of non-display. The desktop screen 61 having been subjected to the mask process of non-display is generated from FIG. 20A and FIG. 20B, as in the mask process described with reference to FIGS. 20A to 20C. That is, the desktop screen 61 having been subjected to the mask process of non-display is generated by displaying the clickable area 51 designated in FIG. 20B and performing the mask process of non-display on the other area.

FIG. 21B illustrates an example of invalidating a widget, which is located in the other area except for the clickable area 51 of FIG. 20B, by making the widget become semi-transparent. The desktop screen 62 having been subjected to the mask process of semi-transparency is generated from FIG. 20A and FIG. 20B, as in the mask process described with reference to FIGS. 20A to 20C. That is, the desktop screen 62 having been subjected to the mask process of semi-transparency is generated by displaying the clickable area 51 designated in FIG. 20B and performing the mask process of semi-transparency on the other area.

FIG. 21C illustrates an example of invalidating the other area except for the clickable area 51 of FIG. 20B by painting the other area with a black color. The desktop screen 63 having been subjected to the mask process by color painting is generated from FIG. 20A and FIG. 20B, as in the mask process described with reference to FIGS. 20A to 20C. That is, the desktop screen 63 having been subjected to the mask process by color painting is generated by displaying the clickable area 51 designated in FIG. 20B and performing the mask process of painting the other area with the black color.

The remote KVM apparatus 101 of FIG. 1 outputs, to the operator, the desktop screen 61 having been subjected to the mask process of non-display, the desktop screen 62 having been subjected to the mask process of semi-transparency, or the desktop screen 63 having been subjected to the mask process by color painting, which are shown in FIGS. 21A to 21C. The operator can know, from each mask-processed desktop screen, an operable content through the remote control in the current state.

Further, in the mask process, a part of widget may be mask-processed. For example, as shown in FIG. 21D or FIG. 21E, a predetermined widget may be mask-processed.

FIG. 21D illustrates an example in which a part of icons have been subjected to the mask process of non-display. FIG. 21D illustrates a desktop screen 64 in which a part of icons have been subjected to the mask process of non-display, as in FIG. 21A. The desktop screen 64 in which a part of icons have been subjected to the mask process of non-display corresponds to an example in which the terminal operation icon 32 of FIG. 10 has been subjected to the non-display. In the case of the desktop screen 64 in which a part of icons have been subjected to the mask process of non-display, the operator can know that the operator is unable to perform only the operation of the terminal operation icon 32.

FIG. 21E illustrates an example in which a part of a window has been subjected to the mask process of non-display. FIG. 21E illustrates a desktop screen 65 in which a part of a window has been subjected to the mask process of non-display, as in FIG. 21A. The desktop screen 65 in which a part of a window has been subjected to the mask process of non-display corresponds to an example in which a window of the network group 35 of FIG. 10, and the mail application soft icon 351 and the network use application soft icon 352 included in the network group 35 are not displayed.

The data for the mask process stored in the storage part 101F2 of FIG. 6 is not limited to data specifying the target to be subjected to the mask process. For example, data, which is not to be subject to the mask process, may be stored, while the other part except for the stored data is subjected to the mask process.

The data for the mask process stored in the storage part 101F2 of FIG. 6 is not limited to image data. The data for the mask process may be, for example, text data storing a character or symbol. The data for the mask process may be, for example, coordinate data for indicating a predetermined range, size, position, or layout of a screen. The data for the mask process may be marker data, such as a QR code™, bar code or the like. The data for the mask process may be, for example, data indicating a layout or a window shape for specifying an error message box.

The restriction process is not limited to a process for performing only the mask process. For example, it is preferable that the restriction process is performed by combining the mask process and the process of invalidating the operation in the mask-processed area. Further, the restriction process may be a process of performing a mask process and an exclusive process preventing a cursor of a mouse from being moved into the mask-processed area. For example, in the case of FIG. 10, it may be performed by combining a process incapable of moving the cursor of the mouse into the other area except for the area of the mail application soft icon 351 with the mask process.

In the third embodiment, the restriction process and the decision process are performed by the remote KVM apparatus 101 as in the first embodiment. Therefore, the necessity for the operator to repair the operator terminal 100 and the manufacturing apparatus 102, for example, to install new software therein, is reduced. Therefore, by the remote KVM apparatus 101, the present disclosure can reduce repairs of a controlling apparatus and a controlled device, and thus can easily construct a system. Further, without the repairs, the system can be constructed.

By performing the mask process, when the remote control is performed, the remote KVM apparatus 101 can notify a dangerous operation to the operator, thereby preventing the operator from performing the dangerous operation. Therefore, by the remote KVM apparatus 101, the operator can perform an operation having a secured safety in the remote control. Further, by performing the mask process, a screen which does not want to display to the operator terminal from the manufacturing apparatus 102, for example, a screen in performing a login operation in the manufacturing apparatus 102, is prevented from being displayed on the operator terminal to thereby enhance the security.

Further, the information processing system 1 may have, for example, a plurality of separate computers (not shown). By the plurality of computers, a part or all of various processes may be performed in parallel or in a distributed manner in order to achieve a high speed processing.

Further, it goes without saying that the system configuration described in the embodiments is an example and the present disclosure includes various system configurations. For example, the processes may be performed by two or more computers through a network in a distributed manner, redundantly, or in parallel. The information used by the information processing apparatus may be stored in two or more storage devices in a distributed manner or redundantly.

Although preferred embodiments of the present invention have been described above, the present disclosure is not limited to such specific embodiments, and various modifications and variations thereof can be made within the scope of the subject matter of the present disclosure set forth in the claims.

For example, the present disclosure may be used in a network system configured with a PC and the like. Further, the present disclosure can be carried out in the fields relating to a manufacturing apparatus for manufacturing a semiconductor, manufacturing a display, such as a Flat Panel Display (FPD), or manufacturing an electronic device and an electronic component, such as a solar cell.

What is claimed is:

1. An information processing apparatus for performing a process for operating a second information processing device by a first information processing device, the information processing apparatus comprising:
an input processing means configured to perform a process for receiving an input data of an operation based on an operation from the first information processing device and an input data of an image based on an operation screen relating to the operation from the second information processing device;
a restriction processing means configured to perform a process for performing a predetermined restriction on the input data of the operation or the input data of the image; and
a storage means configured to store a restriction data including a restriction process content according to a state of the second information processing de vice,
wherein the restriction processing means is configured to acquire the state of the second information processing device based on the input data of the image acquired from the second information processing device, and determine whether to perform the process for performing the predetermined restriction, based on the acquired state and the restriction data.

2. The information processing apparatus of claim 1, further comprising an output processing means configured to perform a process for outputting an output data,
wherein the restriction processing means is configured to perform the process for performing the predetermined restriction on the input data of the operation when it is determined to perform the process for performing the predetermined restriction, and
wherein the output processing means is configured to perform the process for outputting the output data to the second information processing device, based on the data having been subjected to the process for performing the predetermined restriction.

3. The information processing apparatus of claim 1, further comprising an output processing means configured to perform a process for outputting an output data,
wherein the restriction processing means is configured to perform the process for performing the predetermined restriction on the input data of the image when it is determined to perform the process for performing the predetermined restriction, and
wherein the output processing means is configured to perform the process for outputting the output data to the first information processing device, based on the image data having been subjected to the process for performing the predetermined restriction.

4. The information processing apparatus of claim 1, wherein the restriction data comprises one type of data among at least a marker data, an image data, a coordinate data, a layout data, and a character data.

5. The information processing apparatus of claim 1, wherein, when the restriction processing means determines that the process for performing the predetermined restriction is performed, the process for performing the predetermined restriction is a process of masking a part or all of the input data of the image, based on the restriction data.

6. The information processing apparatus of claim 1, wherein the storage means stores a past image data having been previously subjected to the process for performing the predetermined restriction and,
when the restriction processing means determines that the process for performing the predetermined restriction is performed, the process for performing the predetermined restriction is a process of determining whether to perform the process for performing the predetermined restriction, based on the past image data and the input data of the image.

7. An information processing system for performing a process for operating a second information processing device by a first information processing device comprising one or more computers, the information processing system comprising:
an input processing means configured to perform a process for receiving an input data of a operation based on an operation from the first information processing device and an input data of an image based on an operation screen relating to the operation from the second information processing device;
a restriction processing means configured to perform a process for performing a predetermined restriction on the input data of the operation or the input data of the image; and
a storage means configured to store a restriction data including a restriction process content according to a state of the second information processing device,
wherein the restriction processing means is configured to acquire the state of the second information processing device based on the input data of the image acquired from the second information processing device, and determine whether to perform the process for performing the predetermined restriction, based on the acquired state and the restriction data.

8. An information processing method for performing a process for operating a second information processing device by a first information processing device, the information processing method comprising:
performing a process for receiving an input data of a operation based on an operation from the first information processing device and an input data of an image based on an operation screen relating to the operation from the second information processing device;
acquiring a state of the second information processing device based on the input data of the image acquired from the second information processing device;
determining whether to perform a process for performing a predetermined restriction, based on the acquired state and a restriction data;
performing the process for performing the predetermined restriction on the input data of the operation or the input data of the image; and
storing the restriction data including a restriction process content according to a state of the second information processing device.

9. The information processing apparatus of claim 1, wherein the storage means is configured to store setting data input by associating a state of performing a restriction process of the second information processing device with a restriction process content performed by the restriction process.

10. The information processing system of claim 7, wherein the storage means is configured to store setting data input by associating a state of performing a restriction process of the second information processing device with a restriction process content performed by the restriction process.

11. The information processing method of claim 8, further comprising: storing setting data input by associating a state of performing a restriction process of the second information processing device with a restriction process content performed by the restriction process.
